(19) United States
(12) Patent Application Publication
(10) Pub. No.: US 2026/0315845 A1
(43) Pub. Date: Oct. 15, 2026

(54) FIRE APPARATUS

(71) Applicant: Oshkosh Corporation, Oshkosh, WI (US)

(72) Inventors: Chad Ryczek, Oshkosh, WI (US); John Schultz, Oshkosh, WI (US); Ken Sebo, Oshkosh, WI (US); Aaron Zak, Oshkosh, WI (US); Nicole Riggles, Oshkosh, WI (US); David Budiac, Oshkosh, WI (US); Frank Matschnig, Oshkosh, WI (US)

(73) Assignee: Oshkosh Corporation, Oshkosh, WI (US)

(21) Appl. No.: 19/465,433

(22) Filed: Jan. 30, 2026

Related U.S. Application Data
(60) Provisional application No. 63/752,404, filed on Jan. 31, 2025.
(60) Provisional application No. 63/752,415, filed on Jan. 31, 2025.
(60) Provisional application No. 63/752,389, filed on Jan. 31, 2025.
(60) Provisional application No. 63/752,378, filed on Jan. 31, 2025.
(60) Provisional application No. 63/852,622, filed on Jul. 28, 2025.

(51) Int. Cl. A62C 27/00

(52) U.S. Cl. CPC A62C 27/00

(57) ABSTRACT

A fire apparatus includes a chassis, an operator platform coupled to the chassis, and a pump system. The pump system includes a pump configured to provide a flow of a fluid, an inlet fitting defining an inlet configured to supply the fluid to the pump, an outlet fitting defining an outlet configured to discharge the fluid from the pump, and an extension fluidly coupling the inlet fitting and the pump. The extension extends directly beneath the operator platform.

### CROSS-REFERENCE TO RELATED PATENT APPLICATIONS

This applications claims the benefit of and priority to (a) U.S. Provisional Patent Application No. 63/752,378, filed Jan. 31, 2025, (b) U.S. Provisional Patent Application No. 63/752,389, filed Jan. 31, 2025, (c) U.S. Provisional Patent Application No. 63/752,404, filed Jan. 31, 2025, (d) U.S. Provisional Patent Application No. 63/752,415, filed Jan. 31, 2025, and (e) U.S. Provisional Patent Application No. 63/852,622, filed Jul. 28, 2025, all of which are incorporated herein by reference in their entireties.

### BACKGROUND

A fire apparatus can include an on-board pump system that pumps a fluid (e.g., water) from a water source (e.g., a water tank, a fire hydrant, etc.) to one or more outputs of the fire apparatus. The fire apparatus may include onboard controls that facilitate control over the transmission of the fluid into, throughout, and out of the fire apparatus.

### SUMMARY

One embodiment relates to a fire apparatus. The fire apparatus includes a chassis, an operator platform coupled to the chassis, and a pump system. The pump system includes a pump configured to provide a flow of a fluid, an inlet fitting defining an inlet configured to supply the fluid to the pump, an outlet fitting defining an outlet configured to discharge the fluid from the pump, and an extension fluidly coupling the inlet fitting and the pump. The extension extends directly beneath the operator platform.

Another embodiment relates to a fire apparatus. The fire apparatus includes a chassis, a front cabin, a body, an operator platform positioned between the front cabin and the body, and a pump system. The pump system includes a pump positioned forward of the operator platform, an inlet fitting defining an inlet where the inlet is positioned rearward of the operator platform, an extension coupled to the inlet fitting and the pump where the extension extends directly beneath the operator platform, and an outlet fitting coupled to the pump where the outlet fitting defines an outlet positioned forward of the operator platform.

Still another embodiment relates to a fire apparatus. The fire apparatus includes a chassis, a front cabin, a body, a water tank disposed within the body, an operator platform positioned between the front cabin and the body, an operator interface coupled to the body and accessible from the operator platform, and a pump system. The pump system includes a pump positioned forward of the operator platform, an inlet fitting defining an inlet where the inlet is positioned rearward of the operator platform, a conduit coupled to the water tank, a junction coupled to the inlet fitting and the conduit where the junction positioned rearward of the operator platform, an extension coupled to the junction and the pump where the extension extends directly beneath the operator platform, and an outlet fitting coupled to the pump where the outlet fitting defines an outlet positioned forward of the operator platform.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a side view of a fire apparatus, according to an exemplary embodiment.

FIG. 2 is a side view of the fire apparatus with a front cabin in a maintenance position, according to an exemplary embodiment.

FIG. 3 is a front perspective view of the fire apparatus of FIG. 1, according to an exemplary embodiment.

FIG. 4 is a top view of the fire apparatus of FIG. 1, according to an exemplary embodiment.

FIG. 5 is a bottom view of the fire apparatus of FIG. 1, according to an exemplary embodiment.

FIG. 6 is a first side view of the fire apparatus of FIG. 1, according to an exemplary embodiment.

FIG. 7 is a second side view of the fire apparatus of FIG. 1, according to an exemplary embodiment.

FIG. 8 is a front perspective view of a platform assembly of the fire apparatus of FIG. 1, according to an exemplary embodiment.

FIG. 9 is a front view of the platform assembly of FIG. 8 with a pair of ladder assemblies in deployed positions, according to an exemplary embodiment.

FIG. 10 is a front view of a ladder assembly of FIG. 9 in a stored position, according to an exemplary embodiment.

FIG. 11 is a front view of the ladder assembly of FIG. 10 in a both the stored position and the deployed position, according to an exemplary embodiment.

FIG. 12 is a front perspective view of a body and a control panel of the fire apparatus of FIG. 1, according to an exemplary embodiment.

FIG. 13 is a top perspective view of the body and the control panel of FIG. 12, according to an exemplary embodiment.

FIG. 14 is another top perspective view of the body and the control panel of FIG. 12, according to an exemplary embodiment.

FIG. 15 is a top perspective view of the control panel of FIG. 12, according to an exemplary embodiment.

FIG. 16 is a front perspective view of the body of FIG. 12 with the control panel omitted, according to an exemplary embodiment.

FIG. 17 is a side view of an under-console compartments of the body of FIG. 12, according to an exemplary embodiment.

FIG. 18 is a side view of a linkage assembly of the fire apparatus of FIG. 1 connected to a control lever of the control panel of FIG. 12, according to an exemplary embodiment.

FIG. 19 is a block diagram of a pump system of the fire apparatus of FIG. 1 connected to the control lever of FIG. 18, according to an exemplary embodiment.

FIG. 20 is a side view of the fire apparatus of FIG. 1, according to an exemplary embodiment.

FIG. 21 is perspective view of the pump system of FIG. 19, according to an exemplary embodiment.

FIG. 22 is a bottom view of the fire apparatus of FIG. 1, according to an exemplary embodiment.

FIG. 23 is a perspective view of a platform assembly of the fire apparatus of FIG. 1 with a ladder assembly in a fully deployed position, according to an exemplary embodiment.

FIG. 24 is a perspective view of the platform assembly of FIG. 23 with the ladder assembly in the fully deployed position, according to an exemplary embodiment.

FIG. 25 is a front view of the platform assembly of FIG. 23 with the ladder assembly in a stored position, according to an exemplary embodiment.

FIG. 26 is a perspective view of the platform assembly of FIG. 23 with the ladder assembly in the stored position, according to an exemplary embodiment.

FIG. 27 is a side view of the platform assembly of FIG. 23 with the ladder assembly in the stored position, according to an exemplary embodiment.

FIG. 28 is a perspective view of the platform assembly of FIG. 23 with the ladder assembly in the fully deployed position, according to an exemplary embodiment.

FIG. 29 is a perspective view of the platform assembly of FIG. 23 with the ladder assembly in a partially deployed position, according to an exemplary embodiment.

FIG. 30 is a perspective view of the platform assembly of FIG. 23 with the ladder assembly in the stored position, according to an exemplary embodiment.

FIG. 31 is a front view of a latch assembly of the platform assembly of FIG. 23, according to an exemplary embodiment.

FIG. 32 is a side view of the fire apparatus of FIG. 1 with the ladder assembly of FIG. 23 in the fully deployed position, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

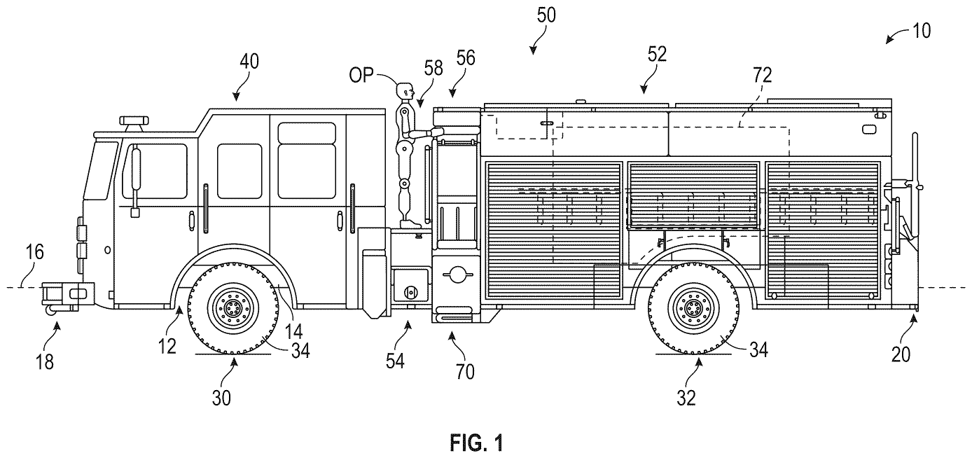

According to the exemplary embodiment shown in FIG. 1, a vehicle or fire truck, shown as fire apparatus 10, is configured as a pumper including a tank (e.g., a water tank) and a pump (e.g., a water pump). In other embodiments, the fire apparatus 10 is configured as a quint fire truck that includes a water tank, an aerial ladder, hose storage, ground ladder storage, and a water pump. In still other embodiments, the vehicle is not a fire truck, but is any other type of vehicle that can include a pump and/or control arrangement similar to the fire apparatus 10, as described in greater detail herein.

As shown in FIG. 1-7, the fire apparatus 10 includes a chassis, shown as frame 12. The frame 12 includes a pair of longitudinal frame rails, shown as frame rails 14, that extend longitudinally along a length of the fire apparatus 10. The frame rails 14 are laterally offset from one another. The frame rails 14 define an axis, shown as longitudinal axis 16, that extends between a first end, shown as front end 18, and an opposing second end, shown as rear end 20, of the fire apparatus 10.

The fire apparatus 10 includes a first axle, shown as front axle 30, and a second axle, shown as rear axle 32, each coupled to the frame 12. The front axle 30 is offset longitudinally forward of the rear axle 32. The front axle 30 and the rear axle 32 each include tractive assemblies, shown as wheel and tire assemblies 34. The wheel and tire assemblies 34 engage a ground surface to support the fire apparatus 10.

The fire apparatus 10 further includes a first assembly or cab assembly, shown as front cabin 40, coupled to and supported by the frame 12. The front cabin 40 is positioned at or near the front end 18 of the frame 12. As shown, the front cabin 40 is positioned forward of the rear axle 32 (e.g., with respect to a forward direction of travel for the fire apparatus 10 along the longitudinal axis 16, etc.) and above the front axle 30. The front cabin 40 is configured to support one or more operators of the fire apparatus 10 (e.g., drivers) and/or one or more passengers. The front cabin 40 may contain controls (e.g., user interface elements, pedals, a steering wheel, knobs, levers, switches, etc.) that permit control over the fire apparatus 10.

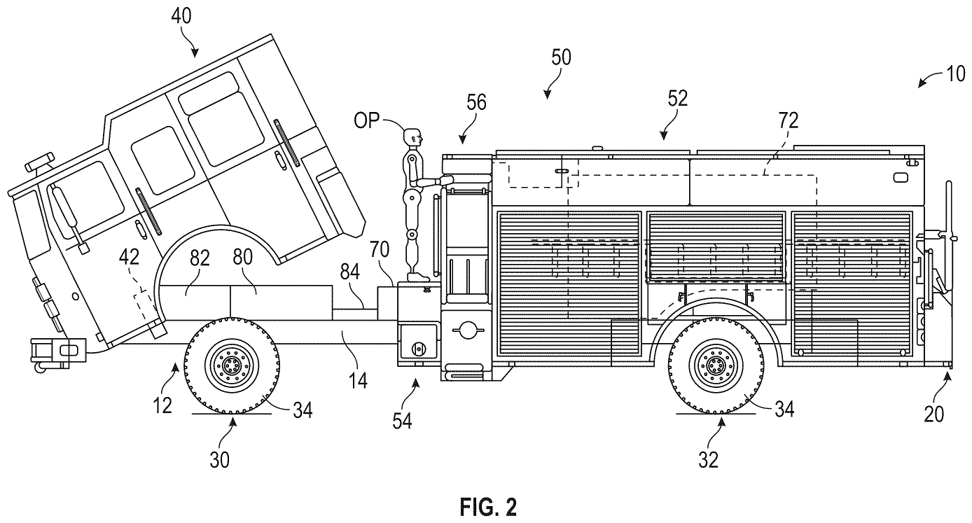

The front cabin 40 may be pivotably coupled to the frame 12 such that the front cabin 40 is repositionable between a use position or lowered position (shown in FIG. 1) and a maintenance or raised position (shown in FIG. 2). Specifically, the front cabin 40 may be rotatable about a lateral axis. In the use position, the front cabin 40 rests atop the frame rails 14 and may be entered by personnel. The use position may be used when operating the fire apparatus 10. In the maintenance position, the front cabin 40 is moved away from the frame rails 14 (e.g., raised) to facilitate access to components of the fire apparatus 10 beneath the front cabin 40. The front cabin 40 may be repositioned by an actuator (e.g., one or more hydraulic cylinders), shown as cabin actuator 42. The cabin actuator 42 is coupled to the frame 12 and the front cabin and configured to raise the front cabin 40 from the use position to the maintenance position.

Referring to FIG. 1-7, the fire apparatus 10 includes equipment or an application kit, shown as rear assembly 50, that is coupled to the frame 12 and positioned longitudinally rearward of the front cabin 40. The rear assembly 50 contains one or more components that perform or facilitates functions of the fire apparatus 10. By way of example, the rear assembly 50 my provide storage, pumping, spraying, and/or other functionality.

The rear assembly 50 includes a body, housing, cabinet, or structure, shown as body 52. The body 52 is coupled to and supported by the frame 12 and includes a series of body panels that define interior and exterior surfaces of the body 52. The body 52 may provide storage for other components of the fire apparatus 10 and tools/equipment used by personnel of the fire apparatus 10.

The fire apparatus 10 includes an operator platform, cockpit, or operator support area, shown as platform assembly 54, and a user interface or control console, shown as control panel 56. The platform assembly 54 is positioned between a front end of the body 52 and a rear end of the front cabin 40. The control panel 56 is coupled to the front end of the body 52 and positioned rearward of the platform assembly 54, such that the platform assembly 54 extends between the front cabin 40 and the control panel 56. The platform assembly 54 defines a top surface that supports an operator OP in a standing position. The top surface of the platform assembly 54 is lower than the respective top surfaces of the front cabin 40 and the control panel 56, such that a space, volume, or walkway, shown as operator compartment 58, is defined between the front cabin 40, the platform assembly 54, and the control panel 56.

To operate the fire apparatus 10, the operator OP may climb from the ground adjacent to the platform assembly 54 onto the platform assembly 54. Once supported by the platform assembly 54 and positioned within the operator compartment 58, the operator OP may face rearward to access the control panel 56. The control panel 56 may include one or more input or output devices (e.g., levers, controls, etc.), through which the operator OP may control operation of the fire apparatus 10. By way of example, the control panel 56 may control the flow of fluid (e.g., water) through the fire apparatus 10. The controls may be positioned at chest height to facilitate ergonomic interaction with the controls by the operator OP.

The fire apparatus 10 further includes a fluid driver, shown as pump system 70, coupled to and supported by the frame 12 and a fluid reservoir, shown as water tank 72, disposed within the body 52 and supported by the frame 12. In some embodiments, the rear assembly 50 additionally or alternatively includes an agent or foam tank (e.g., that receives and stores a fire suppressing agent, foam, etc.). The pump system 70 includes a housing that supports a pump that is configured to drive fluid (e.g., water, agent, etc.) from a fluid source (e.g., the water tank 72, the agent tank, an external source such as a fire hydrant, etc.) to one or more fluid outlets of the fire apparatus 10 (e.g., a structural hose outlet along the body 52; a deluge gun, cannon, or turret; a hose reel; etc.). The water tank 72 is positioned within the body 52 rearward of the pump system 70 and is configured to store a volume of fluid (e.g., water). In this way, the pump system 70 can provide a pressurized flow of fluid from the water tank 72 and/or an external source to address one or more fires.

Referring to FIG. 2, the fire apparatus 10 includes a primary driver, shown as prime mover 80, and an energy storage device, shown as energy storage 82. During operation of the fire apparatus 10, the prime mover 80 consumes energy stored by the energy storage 82 and provides a rotational mechanical energy output to operate one or more components of the fire apparatus 10. By way of example, the rotational mechanical energy output of the prime mover 80 may drive the front axle 30, the rear axle 32, and/or the pump system 70. An output of the prime mover 80 is coupled to the pump system 70 through a power transmission, shown as drive shaft 84.

In some embodiments, the prime mover 80 and the energy storage 82 are part of an internal combustion driveline whereby the prime mover 80 is an internal combustion engine and the energy storage 82 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the prime mover 80 and the energy storage 82 are part of an electric driveline whereby the prime mover 80 is an electric motor and the energy storage 82 is a battery system. In some embodiments, the prime mover 80 and the energy storage 82 are part of a fuel cell electric driveline whereby the prime mover 80 is an electric motor and the energy storage 82 is a fuel cell (e.g., that stores hydrogen, that produces electricity from the hydrogen, etc.). In some embodiments, the prime mover 80 and the energy storage 82 are part of a hybrid driveline whereby (i) the prime mover 80 includes an internal combustion engine and an electric motor/generator and (ii) the energy storage 82 includes a fuel tank and/or a battery system.

### Operator Platform

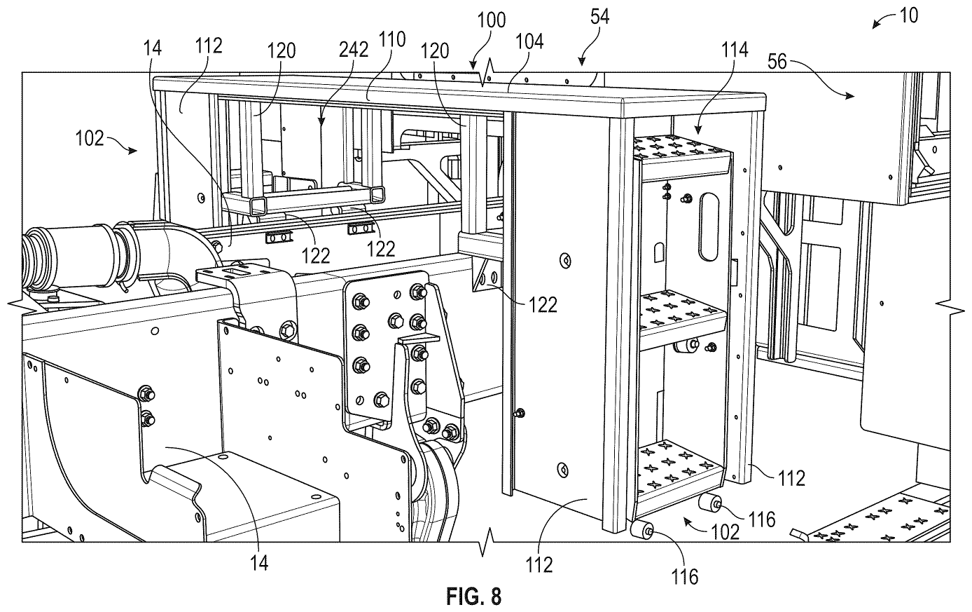

Referring to FIG. 8-11, the platform assembly 54 is shown according to an exemplary embodiment. The platform assembly 54 includes a stationary portion, base, or receiver, shown as platform frame 100, and a pair of deployable access assemblies, ladders, stairs, or steps, shown as ladder assemblies 102. The platform frame 100 is fixedly coupled to the frame 12 and defines a top surface or walkway surface, shown as operator support surface 104, that is configured to support the operator OP. The platform frame 100 extends laterally beneath the operator compartment 58 from a left side of the fire apparatus 10 to a right side of the fire apparatus 10. As shown in FIG. 1, the placement of the platform assembly 54 may permit the operator OP to see over the top of the front cabin 40 and the body 52, providing the operator OP with maximized visibility.

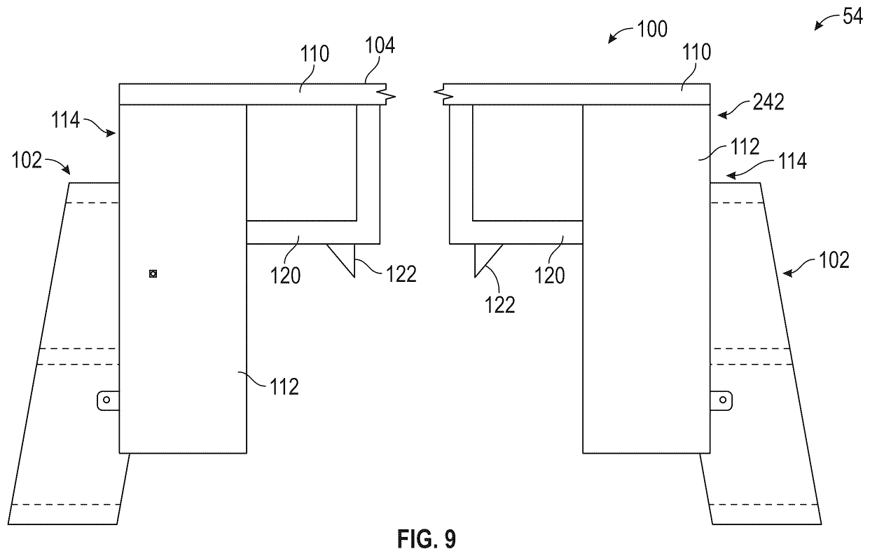

One ladder assembly 102 is positioned on a left side of the fire apparatus 10, and another ladder assembly 102 is positioned on a right side of the fire apparatus 10. The ladder assemblies 102 are arranged to be laterally symmetric about a longitudinal centerline of the fire apparatus 10. Each ladder assembly 102 is movably coupled to the platform frame 100, such that the ladder assemblies 102 are each repositionable between a stored position (shown in FIG. 8) and a deployed position (shown in FIG. 9). In the stored position, the ladder assemblies 102 are retracted upward away from the ground and into the platform frame 100. In the deployed position, the ladder assemblies 102 extend downward from the platform frame 100 to facilitate access to the operator support surface 104 by the operator OP (e.g., facilitating climbing from the ground or a ground surface onto the operator support surface 104).

The platform frame 100 includes a horizontal member, plank, or support, shown as platform 110. The platform 110 extends laterally between the left and right sides of the fire apparatus 10 and longitudinally between the front cabin 40 and the control panel 56. The platform 110 defines the operator support surface 104 and is configured to support the weight of the operator OP.

Two pairs of plates, shown as side panels 112, are fixedly coupled to the platform 110 at each lateral end of the platform 110. The first pair of side panels 112 are longitudinally offset from one another (e.g., one is positioned forward of the other), such that a space, volume, or recess, shown as ladder recess 114, is defined between the platform 110 and the side panels 112. The ladder recess 114 of the first pair of side panels 112 receives a first ladder assembly 102 at least when the ladder assembly 102 is in the stored position. The second pair of side panels 112 form a similar arrangement on the opposite side of the platform 110, such that both ladder recesses 114 face laterally outward, away from the frame 12. A compliant member (e.g., cushion, rubber member, etc.), shown as stop 116, is fixedly coupled to a lower end portion of each side panel 112.

The platform frame 100 further includes a series of frame members, shown as standoffs 120, which are fixedly coupled to the underside of the platform 110 and the inner sides of the side panels 112. The standoffs 120 extend downward and inward toward the frame 12. The standoffs 120 support and fixedly couple the side panels 112 to the platform 110. A series of mounting brackets 122 fixedly couple the standoffs 120 to the frame 12. Accordingly, the platform 110 and the side panels 112 are fixedly coupled to the frame 12 through the standoffs 120 and the mounting brackets 122.

Each of the ladder assemblies 102 includes a pair of upright members, shown as side panels 130, and a series of longitudinal members, stairs, steps, or rungs, shown as steps 132. The side panels 130 extend substantially vertically and laterally. The side panels 130 are longitudinally offset from one another. The steps 132 each extend longitudinally between the side panels 130 and are fixedly coupled to the side panels 130 to form a ladder assembly 102. Each of the steps 132 has a top surface that is configured to support a foot or a hand of the operator OP to facilitate the operator OP scaling the ladder assembly 102 and accessing the operator support surface 104. Although the ladder assembly 102 is shown with three steps 132, each ladder assembly 102 may include more or fewer steps 132 in other embodiments.

Each ladder assembly 102 is movably coupled to the platform frame 100 by a series of linkages or couplers, shown as upper links 140 and lower links 142. An upper link 140 and a lower link 142 are positioned between each adjacent pair of side panels 112 and side panels 130. For ease of description, one assembly of an upper link 140, a lower link 142, a side panel 112, and a side panel 130 are described, but it should be understood that each upper link 140 and lower link 142 may have a similar arrangement.

The upper link 140 has a first end portion that is pivotably coupled to the side panel 112 of the platform frame 100 and an opposing second end portion that is pivotably coupled to the side panel 130 of the ladder assembly 102. The first end portion of the upper link 140 is rotatable relative to the side panel 112 about a first longitudinal axis of rotation, shown as axis 144. The second end portion of the upper link 140 is rotatable relative to the side panel 130 about a second longitudinal axis of rotation, shown as axis 146.

The lower link 142 has a first end portion that is pivotably coupled to the side panel 112 of the platform frame 100 and an opposing second end portion that is pivotably coupled to the side panel 130 of the ladder assembly 102. The first end portion of the lower link 142 is rotatable relative to the side panel 112 about a first longitudinal axis of rotation, shown as axis 148. The second end portion of the lower link 142 is rotatable relative to the side panel 130 about a second longitudinal axis of rotation, shown as axis 150.

The platform frame 100, the ladder assembly 102, the upper links 140, and the lower links 142 form a four bar linkage that permits rotational and translational movement of the ladder assembly 102 relative to the platform frame 100. The upper links 140 and the lower links 142 permit the ladder assembly 102 to follow a predetermined path between the stored position and the deployed position. In some embodiments, the ladder assemblies 102 are movable independent of one another.

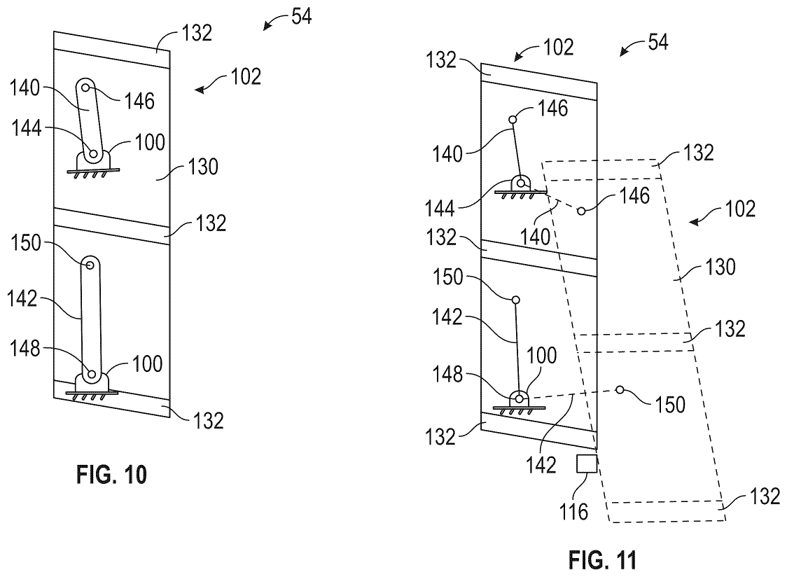

In the stored position of the ladder assembly 102 (shown in FIGS. 8 and 10 and in solid lines in FIG. 11), the ladder assembly 102 is retracted into the ladder recess 114. In this position, the ladder assembly 102 is oriented substantially vertically to reduce or limit the footprint of the ladder assembly 102. As the ladder assembly 102 may be used infrequently or not used at all in the stored position, the steps 132 may be angled relative to a horizonal plane without impacting the experience of the operator.

In the stored position, the upper link 140 extends upward from the axis 144 to the axis 146, and the lower link 142 extends upward from the axis 148 to the axis 150. Accordingly, the upper link 140 and the lower link 142 may swing downward to move the ladder assembly 102 to the deployed position. In some embodiments, the upper link 140 and the lower link 142 are moved over center when in the stored position, such that (a) the axis 146 is positioned laterally inward of the axis 144 and/or (b) the axis 150 is positioned laterally inward of the axis 148. In such a configuration, a downward force on the ladder assembly 102 (e.g., due to gravity) may cause the ladder assembly 102 to move further inward, retaining the ladder assembly 102 in the stored position. In such a configuration, a user may be required to manually lift up on the ladder assembly 102 to deploy the ladder assembly 102, preventing unintentional deployments. Additionally or alternatively, the ladder assembly 102 may be selectively retained in the stored position by a biasing element (e.g., a spring) and/or by a latch.

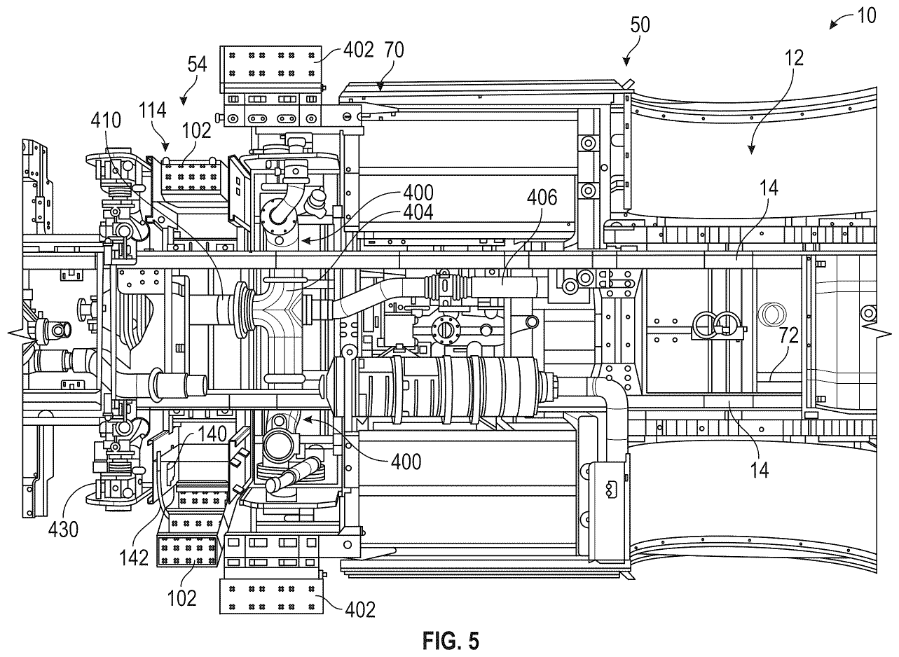

In the deployed position of the ladder assembly 102 (shown in FIGS. 5 and 9 and in dashed lines in FIG. 11), the ladder assembly 102 is deployed from the ladder recess 114. In this deployed position, the ladder assembly 102 extends laterally outward of and below the ladder recess 114. The ladder assembly 102 is angled relative to a vertical axis, such that the steps 132 are oriented horizontally. This horizontal orientation of the steps 132 may facilitate a sure footing of the operator OP as the operator scales or descends on the ladder assembly 102.

In the deployed position, the upper link 140 extends laterally outward from the axis 144 to the axis 146, and the lower link 142 extends laterally outward from the axis 148 to the axis 150. Accordingly, the upper link 140 and the lower link 142 have swung downward relative to the stored position to move the ladder assembly 102 to the deployed position. As shown in FIG. 11, the ladder assembly 102 rests against the stops 116 while in the deployed position to limit (e.g., prevent) further lateral movement inward toward the frame 12. Accordingly, the stops 116 may define the deployed position of the ladder assembly 102. To move the ladder assembly 102 from the deployed position to the stored position, a user may lift upward on the ladder assembly 102 to move the ladder assembly 102 away from the stops 116.

Referring to FIG. 1-11, an operator OP may use the platform assembly 54 for access to and egress from the operator compartment 58. The fire apparatus 10 may arrive at a scene of an incident (e.g., a fire, a medical emergency, etc.) with the ladder assemblies 102 in the stored positions. The operator OP may approach the fire apparatus 10 from the left or the right side (e.g., after exiting the front cabin 40 or another vehicle at the scene). The operator OP may apply an outward and/or downward force to move the ladder assembly 102 corresponding to the side where the operator OP is positioned from the stored position to the deployed position. The operator OP may then climb up the steps 132 of the ladder assembly 102 and the operator support surface 104 to stand within the operator compartment 58. The operator OP may then operate the control panel 56 from atop the operator support surface 104. When the operator OP is finished (e.g., a fire has been extinguished), the operator OP may descend from the operator support surface 104 to the steps 132 and from the steps 132 to the ground. The operator OP may then apply an upward and/or inward force to move the ladder assembly 102 to the stored position. With both ladder assemblies 102 in the stored positions, the fire apparatus 10 may be ready for transit. At any point throughout this process, a second operator OP may deploy the other ladder assembly 102 and use that ladder assembly 102 to access the operator compartment 58. While described herein as being manually operated, in some embodiments, the ladder assembly 102 (a) has user-assist components (e.g., pneumatic dampers, biasing springs, etc.) to assist the operator OP with deploying or stowing the ladder assembly 102 and/or (b) has actuators (e.g., hydraulic actuators, electric actuators, actuators 582, etc.) that deploy or stow the ladder assembly 102 in response to a command signal (e.g., from the operator OP engaging a user interface, a button, a switch, the upper switch 610, the lower switch 612, etc.).

### Control Panel and Body Storage

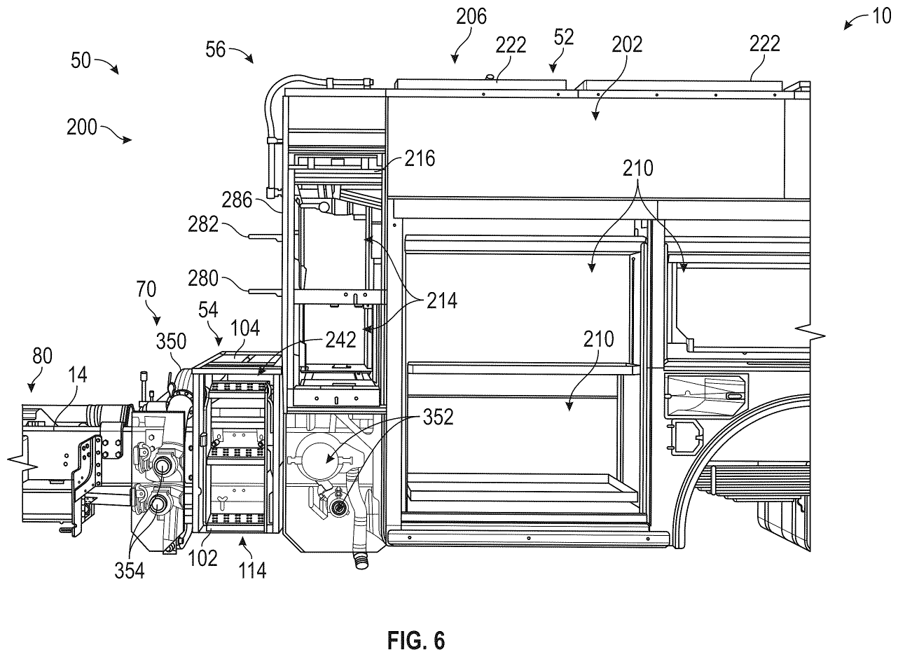

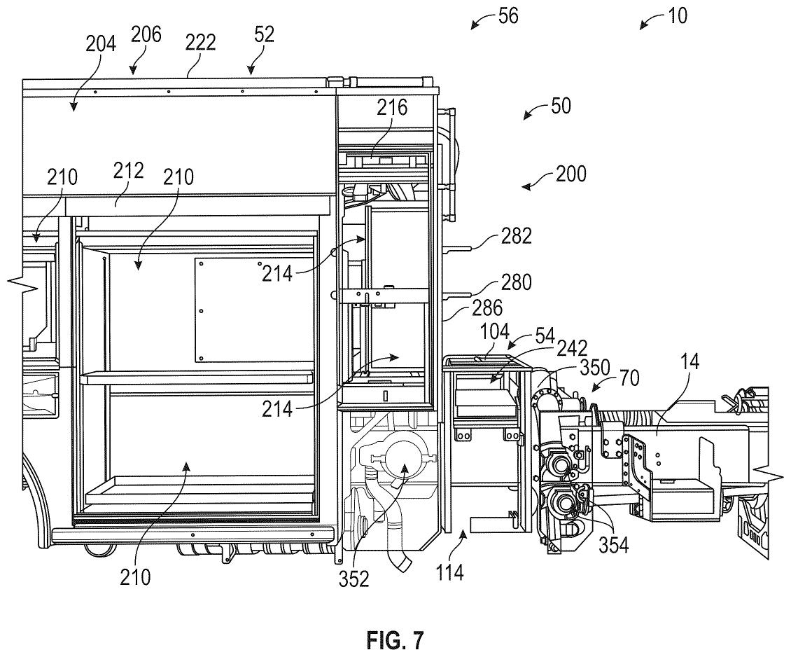

Referring to FIGS. 6 and 7, the body 52 includes a series of body panels that define a forward-facing or operator side, shown as front side 200, a first laterally-facing side or left side, shown as driver side 202, a second laterally-facing side or right side, shown as passenger side 204, and an upward-facing side, shown as top side 206. The front side 200 extends vertically downward from the top side 206 and laterally between the driver side 202 and the passenger side 204. The front side 200 faces toward the front cabin 40. The driver side 202 and the passenger side 204 each extend downward from the top side 206 and longitudinally rearward from the front side 200. The driver side 202 and the passenger side 204 each face laterally outward in opposing directions. The top side 206 extends horizontally between the front side 200, the driver side 202, and the passenger side 204. The top side 206 faces upward.

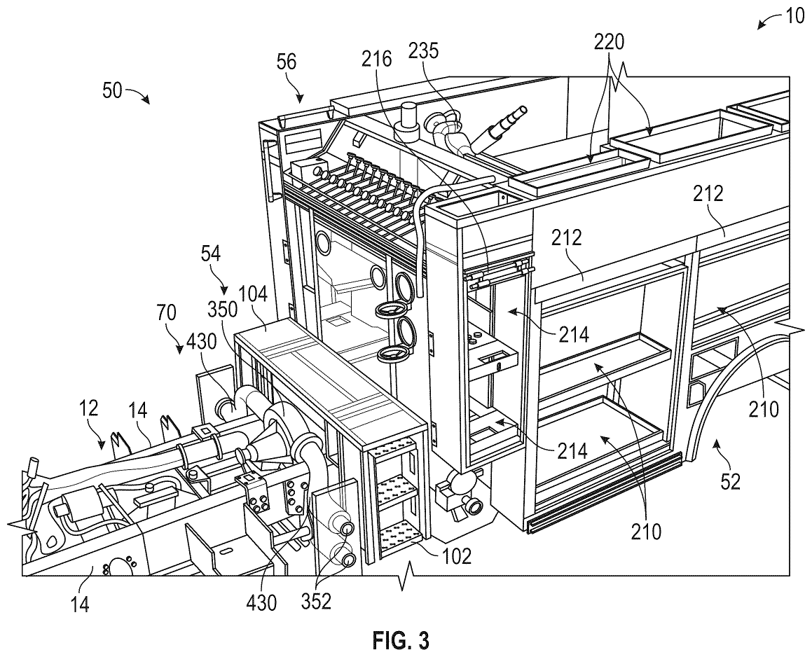

Referring to FIGS. 3, 6, and 7, the body 52 defines a series of storage compartments or recesses, shown as side compartments 210. The side compartments 210 extend laterally inward from the driver side 202 or the passenger side 204 toward a longitudinal centerline of the fire apparatus 10. Each of the side compartments 210 is enclosed on the bottom, top, forward, backward, and inward sides and exposed on a laterally outward side. The exposed sides of the side compartments 210 may be covered by doors, covers, panels, or barriers, shown as side doors 212. As shown, the side doors 212 are each positioned along the left or right side of the body 52. In some embodiments, the side door 212 roll up for storage (e.g., are made from a series of pivotably-connected segments that can form a coil or roll). The side door 212 may be opened to permit storage of items within the side compartments 210 and closed to secure the items within the side compartments 210.

The body 52 further defines a pair of laterally-extending storage compartments, shown as under-console compartments 214. The under-console compartments 214 extend beneath the control panel 56 from the driver side 202 to the passenger side 204 of the body 52. In some embodiments, the under-console compartments 214 extend completely through the body 52, such that an item may pass into an under-console compartment 214 from the driver side 202 and exit the under-console compartment 214 from the passenger side 204. As shown, a first under-console compartment 214 is positioned above a second under-console compartment 214 (e.g., such that the under-console compartments 214 are separated by a shelf).

The left and right sides of the under-console compartments 214 may be covered by doors, covers, panels, or barriers, shown as side doors 216. As shown, the side doors 216 are each positioned along the left or right side of the body 52. In some embodiments, the side doors 216 roll up for storage (e.g., are made from a series of pivotably-connected segments that can form a coil or roll). The side doors 216 may be opened to permit storage of items within the under-console compartments 214 and closed to secure the items within the under-console compartments 214. As shown, each side door 216 extends across both of the under-console compartments 214.

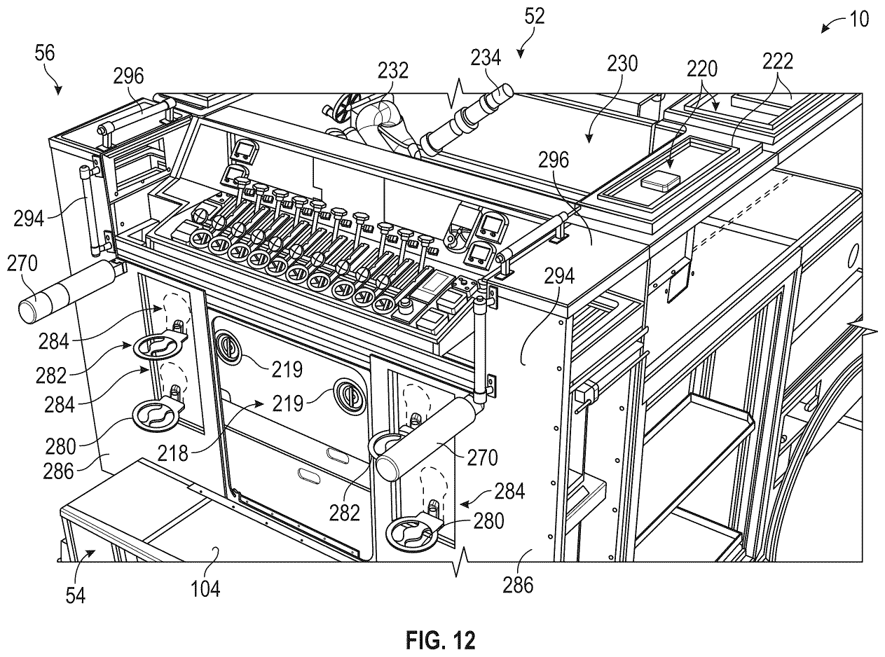

As shown in FIG. 12, a removable panel or door, shown as front door 218, covers a front side of the under-console compartments 214. As shown, the front door 218 is positioned along the front side 200 of the body 52 and beneath the control panel 56. The front door 218 is a single solid panel and extends across the fronts side of both of the under-console compartments 214. A pair of latches, locks, or catches, shown as locking knobs 219, are positioned near a top end of the front door 218 and selectively couple the front door 218 to the body 52. By way of example, a lower end portion of the front door 218 may be received within a slot or groove of the body 52 near the operator support surface 104. The locking knobs 219 may selectively engage the body 52 (e.g., in response to the operator OP twisting the locking knobs 219) to secure the front door 218 to the body 52 or release the front door 218 from the body 52. When closed (e.g., as shown in FIG. 12), the front door 218 extends across and blocks a passage of the body 52 that permits access to the under-console compartments 214 from the operator compartment 58 (e.g., access from along front side 200). When removed, the operator OP may reach through the passage to access the under-console compartments 214 (e.g., to access items stored within the under-console compartments 214). Removal of the front door 218 may further facilitate access to the control levers 252 and the linkage assemblies 300 as described herein (e.g., for maintenance). Other fire apparatuses that do not utilize the front door 218 may require lifting of a front cabin or body to access such components for maintenance.

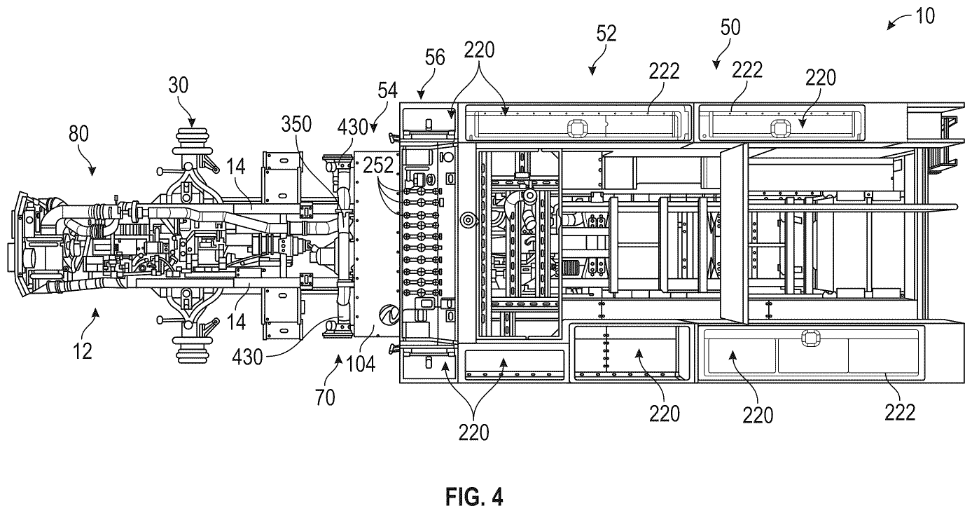

Referring to FIGS. 4, 6, 7, and 12-14, the body 52 further defines a series of storage compartments or recesses, shown as top compartments 220. The top compartments 220 extend downward from the top side 206. Each of the top compartments 220 is enclosed on the bottom, forward, backward, left, and right sides and exposed on a top side. The exposed top sides of the top compartments 220 may be covered by doors, covers, panels, or barriers, shown as doors 222. In some embodiments, the doors 222 are hinged to permit movement between an open position and a closed position. The doors 222 may be opened to permit storage of items within the top compartments 220 and closed to secure the items within the top compartments 220.

The side compartments 210, the console compartments 214, and the top compartments 220 may store a variety of different items. By way of example, the side compartments 210 and the console compartments 214 may contain equipment such as tools (e.g., axes, sledgehammers, pry bars, wrenches, etc.), nozzles, hose adapters, hoses, first aid kits, foam systems, valves, or other equipment.

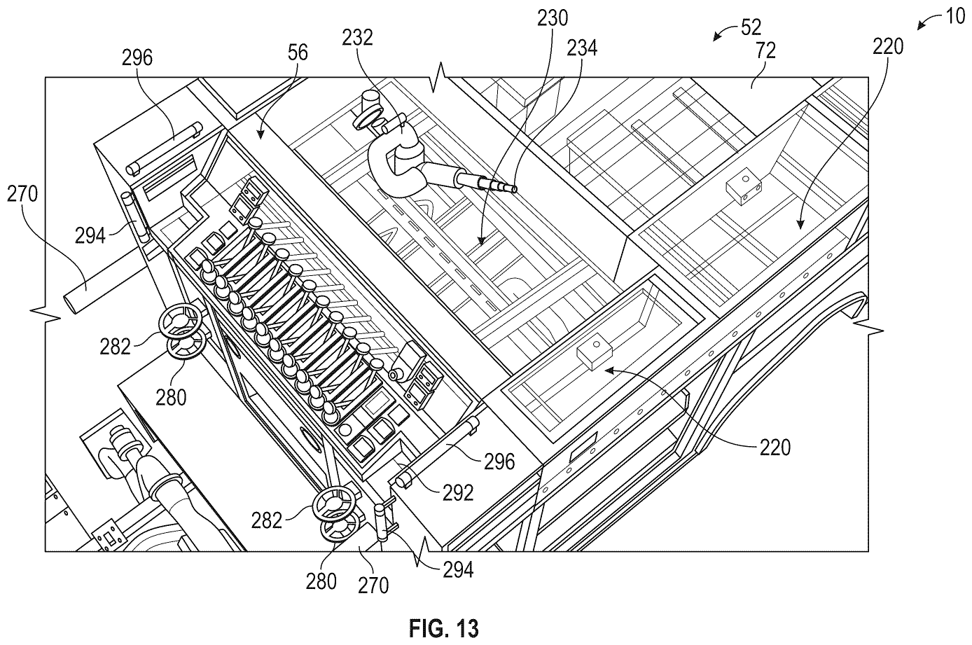

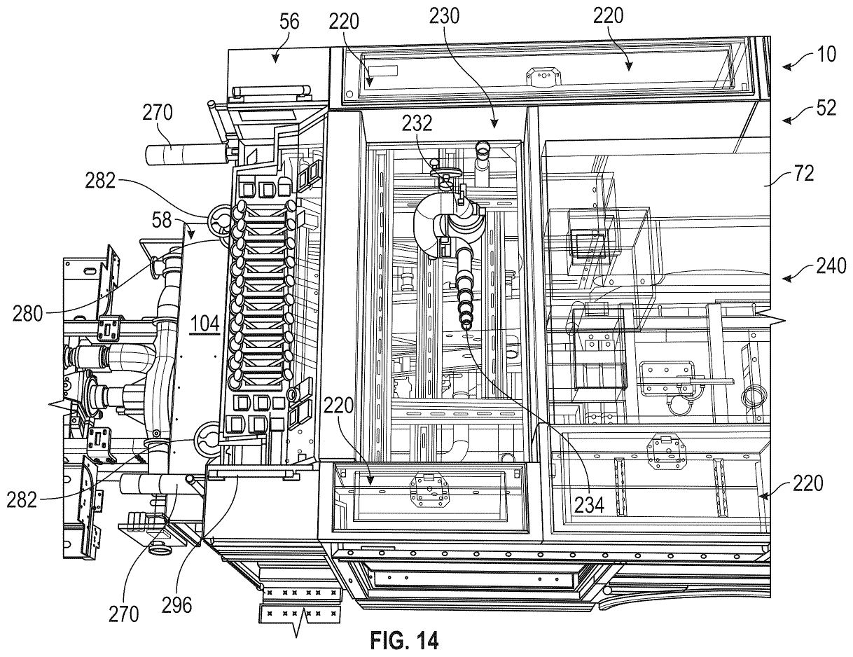

Referring to FIGS. 13 and 14, the body 52 further defines a recess or compartment, shown as monitor compartment 230. The monitor compartment 230 is positioned along a rear side of the control panel 56 and is substantially laterally centered between the top compartments 220. The monitor compartment 230 extends downward from the top side 206 and into the body 52. The monitor compartment 230 is enclosed on the bottom, forward, backward, left, and right sides and exposed on a top side.

The monitor compartment 230 receives a nozzle assembly, turret, or deluge, shown as monitor 232, that is pivotably coupled to the body 52. The monitor 232 includes a nozzle defining an outlet 234 that is fluidly coupled to the pump system 70. The monitor 232 is configured to direct pressurized fluid (e.g., water, agent, etc.) from the pump system 70 through the outlet 234 to form a stream of fluid. The monitor 232 may be rotatable about a substantially vertical axis to vary a direction of the stream of fluid. The monitor 232 may be repositioned manually or automatically by one or more actuators. In some embodiments, the monitor compartment 230 is sized to permit a full rotation of the monitor 232 without the monitor 232 contacting the walls of the monitor compartment 230. In some embodiments, the monitor compartment 230 is sized to permit an operator to sit or stand within the monitor compartment 230 adjacent to the monitor 232.

Referring still to FIGS. 13 and 14, the body 52 further defines a recess or compartment, shown as hose bed compartment 240. The hose bed compartment 240 is positioned along a rear side of the monitor compartment 230 and is substantially laterally centered between the top compartments 220. The hose bed compartment 240 extends downward from the top side 206 to a top surface of the water tank 72. The hose bed compartment 240 is enclosed on the bottom, forward, backward, left, and right sides and exposed on a top side. The hose bed compartment 240 may contain one or more hoses or conduits (e.g., configured to transfer fluid to or from the pump system 70).

Referring to FIG. 6-9 and 20, the platform assembly 54 defines a laterally-extending storage compartment, shown as under-walkway compartment 242, defined between the platform 110 and the side panels 112. The under-walkway compartment 242 extends vertically between the frame 12 and the operator support surface 104. The under-walkway compartment 242 extends beneath the operator support surface 104 from the ladder recess 114 on the driver side 202 to the ladder recess 114 on the passenger side 204 of the platform assembly 54. In some embodiments, the under-walkway compartment 242 extends completely through the body 52, such that an item may pass into the under-walkway compartment 242 from the driver side 202 and exit the under-walkway compartment 242 from the passenger side 204. In other embodiments, the platform assembly 54 defines two under-walkway compartments 242 that are aligned with one another but obstructed from connecting with one another. In such an embodiment, each under-walkway compartment 242 may extend inward from and be accessed from a corresponding side of the fire apparatus 10.

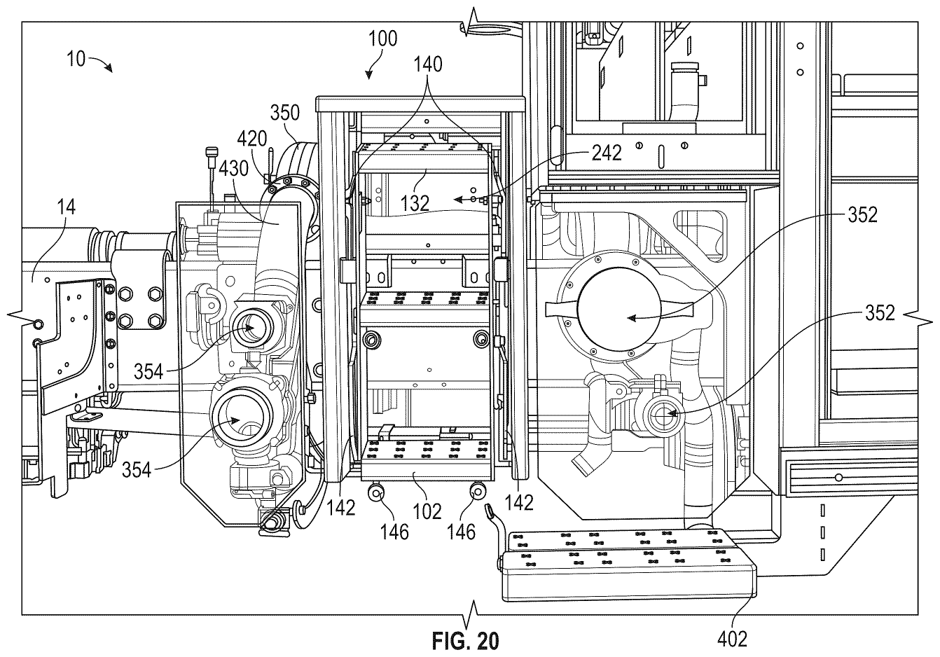

As shown in FIGS. 8 and 20, when each ladder assembly 102 is in the stored position (e.g., as shown in FIG. 8), the uppermost step of the steps 132 overlaps the under-walkway compartment 242. This overlap causes the steps 132 to obscure or hinder access to the under-walkway compartment 242 and may limit (e.g., prevent) items from being added to or removed from the under-walkway compartment 242 (e.g., may retain items within the under-walkway compartment 242, functioning as a lid or cover). As shown in FIG. 9, when each ladder assembly 102 is in the deployed position, the steps 132 are positioned below the under-walkway compartment 242, such that the under-walkway compartment 242 may be accessed freely.

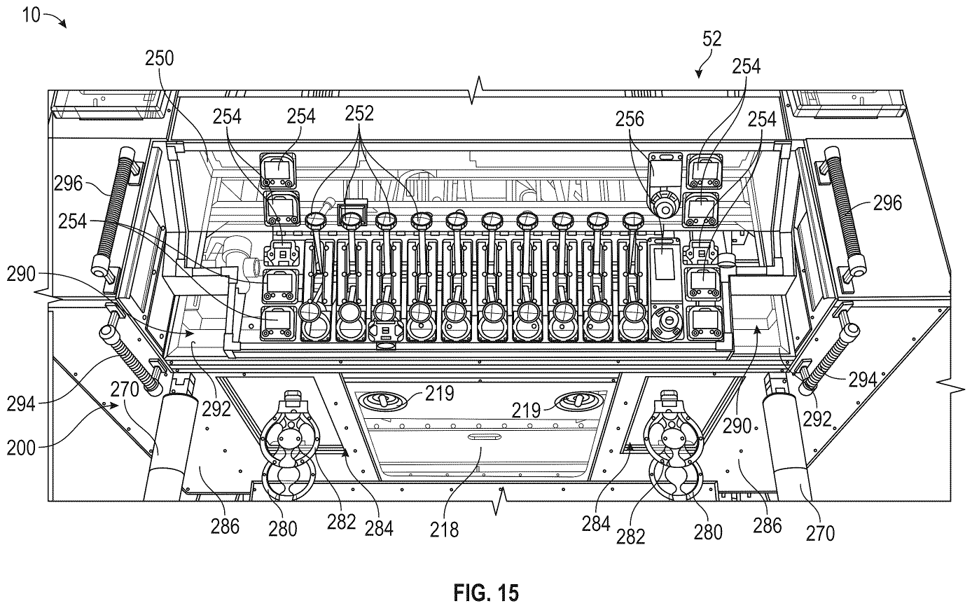

Referring to FIG. 15, the control panel 56 includes a plate, shown as interface panel 250, that supports a series of user interface elements (e.g., input devices, output devices, etc.). Specifically, the control panel 56 includes a series of input devices, shown as control levers 252, that are arranged in a laterally-extending row on the interface panel 250. The control levers 252 may each be repositionable by the operator OP between a forward position and a rear position to control a different function of the fire apparatus 10. By way of example, each of the control levers 252 may control a different function of the pump system 70 (e.g., opening, closing, or otherwise repositioning a valve to control the flow of fluid through the pump system 70). The control panel 56 further includes a series of input and/or output devices, shown as gauges 254, coupled to the interface panel 250. The gauges 254 may provide (e.g., visually display) information to the operator OP (e.g., engine speed, fuel levels, sensor data for troubleshooting, etc.). The control panel 56 includes a pair of input and/or output devices, shown as control knobs 256, coupled to the interface panel 250. The control knobs 256 may receive inputs (e.g., commands) from the operator OP. By way of example, the control knobs 256 may be used to control operation of the monitor 232 of FIG. 13 or other monitors 232 of the fire apparatus 10. In some embodiments, the control levers 252, the gauges 254, and/or the control knobs 256 are in communication with a control system of the fire apparatus 10 (e.g., an onboard vehicle controller).

The interface panel 250 is positioned to facilitate access to the control levers 252, the gauges 254, and the control knobs 256 by an operator OP standing on the operator support surface 104 within the operator compartment 58 and facing rearward. The interface panel 250 is oriented to face upward and forward, such that the control levers 252, the gauges 254, and the control knobs 256 are all visible to the operator OP. In some embodiments, the control levers 252, the gauges 254, and the control knobs 256 are positioned near a chest height of the operator OP such that the hands of the operator OP can reach the control panel 56 without the operator OP having to bend over.

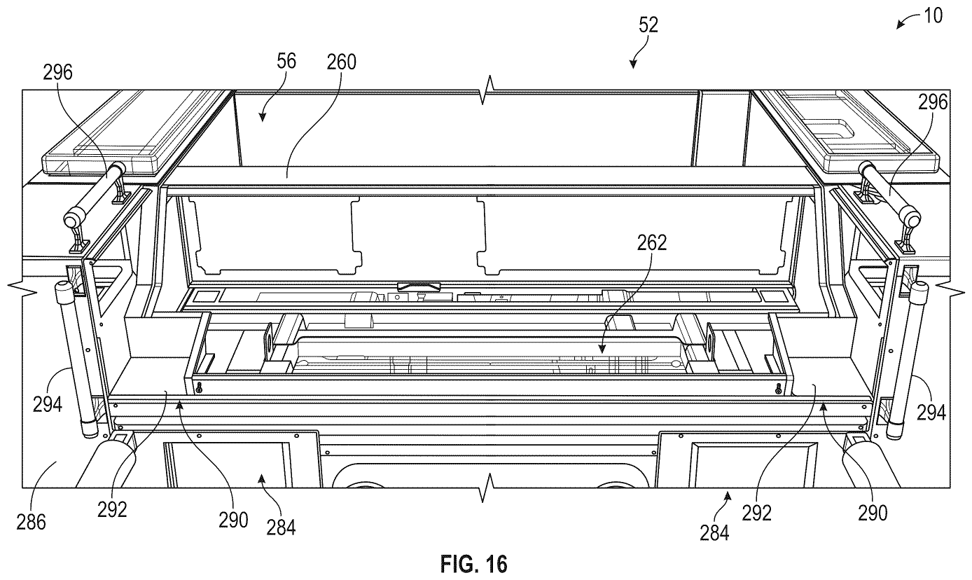

As shown in FIGS. 15 and 16, the control panel 56 includes a frame assembly or subframe, shown as control panel frame 260, that extends beneath the interface panel 250. The interface panel 250 is fixedly coupled to the control panel frame 260, and the control panel frame 260 is fixedly coupled to the body panels of the body 52. Accordingly, the control panel frame 260 supports the interface panel 250, the control levers 252, the gauges 254, and the control knobs 256. The body 52 defines an aperture or passage, shown as linkage passage 262, that extends vertically into the body 52 beneath the control levers 252.

Referring to FIG. 12-15, the fire apparatus 10 includes a pair of deployable railings or barriers, shown as railings 270, that are fixedly coupled to the front side 200 of the body 52. The railings 270 extend forward from the front side 200 toward the front cabin 40. The railings 270 are laterally offset from one another and offset above the operator support surface 104, such that the railings 270 act as left and right boundaries of the operator compartment 58. The railings 270 may facilitate containing the operator OP within the operator compartment 58, preventing unintended egress from the operator compartment 58. In some embodiments, the operator OP may move out of the operator compartment 58 by ducking beneath the railings 270. In other embodiments, the railings 270 are selectively rotatable (e.g., downward) from a deployed position (e.g., as shown in FIG. 15) to a stored position adjacent the front side 200 of the body 52 to facilitate egress from the operator compartment 58.

Referring to FIG. 12-16, the fire apparatus 10 includes a series of deployable steps, rungs, or supports, shown as deployable steps 280 and deployable steps 282, coupled to the body 52. The deployable steps 280 and the deployable steps 282 are positioned along the front side 200 of the body 52. Specifically, the fire apparatus 10 includes a pair of deployable steps 280 and a pair of deployable steps 282. A first deployable step 280 and a first deployable step 282 are positioned on a first side (e.g., a left side) of the control panel 56, and a second deployable step 280 and a second deployable step 282 are positioned on a second side (e.g., a right side) of the control panel 56. The deployable steps 282 are positioned above the deployable steps 280. The deployable steps 280 and the deployable steps 282 are all positioned below the control panel 56 on opposing sides of the front door 218.

The front side 200 of the body 52 defines a pair of recesses, shown as deployable step recesses 284, that extend rearward into the body 52 from a front surface 286 of the body 52. Each deployable step recess 284 receives one of the deployable steps 280 and one of the deployable steps 282. The deployable step recesses 284 extend vertically between the operator support surface 104 and the control panel 56.

The deployable steps 280 and the deployable steps 282 are each pivotably coupled to the body 52, such that the deployable steps 280 and the deployable steps 282 are repositionable between an extended or deployed position (shown in solid lines in FIG. 12) and a retracted or stored position (shown in dashed lines in FIG. 12). The deployable steps 280 and the deployable steps 282 may be moved from the deployed position to the stored position by applying an upward force onto the deployable step 280 or the deployable step 282. Similarly, the deployable steps 280 and the deployable steps 282 may be moved from the stored position to the deployed position by applying a downward force onto the deployable step 280 or the deployable step 282. The deployable steps 280 and the deployable steps 282 may each be moved independent of one another.

In the deployed position, the deployable steps 280 and the deployable steps 282 are each oriented substantially horizontally, defining a horizontal top surface that is capable of supporting a limb (e.g., a foot) of the operator OP. In the deployed position, the deployable steps 280 and the deployable steps 282 extend forward, away from the front side 200, out of the deployable step recesses 284, and past the front surface 286. Accordingly, the deployable steps 280 and the deployable steps 282 protrude beyond the front surface 286 (e.g., as shown in FIGS. 6 and 7). The deployable steps 280 are vertically offset above the operator support surface 104, the deployable steps 282 are vertically offset above the deployable steps 280, and the control panel 56 is vertically offset above the deployable steps 282. On each side of the control panel 56, a deployable step 282 is positioned below the control panel 56, a deployable step 280 extends beneath the deployable step 282, and the operator support surface 104 extends beneath the deployable step 280. In the deployed position, the deployable steps 280 and the deployable steps 282 may each be configured to bear the weight of the operator OP.

In the stored position, the deployable steps 280 and the deployable steps 282 are each oriented substantially vertically. The deployable steps 280 and the deployable steps 282 are received within the deployable step recesses 284. The thickness of the deployable steps 280 and the deployable steps 282 may be less than the longitudinal depth of the deployable step recesses 284, such that the deployable steps 280 and the deployable steps 282 are inset relative to the front surface 286. This arrangement may remove the deployable steps 280 and the deployable steps 282 from the operator compartment 58 when not in use and prevent accidental contact with the deployable steps 280 and the deployable steps 282 by the operator OP.

Referring to FIGS. 15 and 16, the interface panel 250 and the control panel frame 260 define a pair of cutouts or recesses, shown as step recesses 290. The step recess 290 are positioned on the left and right sides of the control panel 56 and extend rearward from the front side 200 of the body 52. A top surface of the body 52 that is exposed by the step recesses 290 defines a pair or rungs, steps, or supports, shown as control panel steps 292. The portions of the control panel frame 260 defining the step recesses 290 extend upward from the control panel steps 292 and frame the control panel steps 292 along the rear side and an inward lateral side. The control panel steps 292 are positioned above the deployable steps 280 and the deployable steps 282. The control panel steps 292 may each be configured to bear the weight of the operator OP. By forming the interface panel 250 and the control panel frame 260 into a cutout around the step recesses 290, the control panel 56 can extend to the same lateral position as the control panel steps 292, permitting the placement of the control panel steps 292 without having to decrease an overall width of the interface panel 250. Accordingly, the width of the interface panel 250 is increased, permitting placement of additional input and/or output devices (e.g., additional control levers 252, gauges 254, and/or control knobs 256).

Referring to FIG. 12-16, the fire apparatus 10 further includes a series of handrails or supports, shown as side rails 294 and top rails 296. The side rails 294 are fixedly coupled to the body 52 along the front side 200. The top rails 296 are fixedly coupled to the body 52 along the top side 206. The control panel 56 is positioned between the side rails 294 and between the top rails 296. The side rails 294 and the top rails 296 provide solid points of contact for the operator OP to grip and steady themselves while navigating the fire apparatus 10.

Referring to FIG. 12-16, the operator OP may utilize the deployable steps 280, the deployable steps 282, and/or the control panel steps 292 to facilitate climbing from the operator support surface 104, over the control panel 56, and into the monitor compartment 230. From the monitor compartment 230, the operator OP may access the monitor 232, the top compartments 220, and/or the hose bed compartment 240. Accordingly, the deployable steps 280, the deployable steps 282, and the control panel steps 292 may facilitate using the top side 206 of the body 52 for storage.

An example of how the deployable steps 280, the deployable steps 282, and the control panel steps 292 may be used will now be described. Throughout this process, the operator OP may engage one or more of the side rails 294 or the top rails 296 with their hands to steady themselves. An operator OP may begin by moving a deployable step 280 and a deployable step 282 to the respective deployed positions. The operator OP may select a deployable step 280 and a deployable step 282 on a common side of the control panel 56 (e.g., a left side or a right side). The operator OP may step from the operator support surface 104 onto the deployable step 280 with a first foot, supporting their weight on the deployable step 280. The operator OP may then raise a second foot from the operator support surface 104 onto the deployable step 282, supporting their weight on the deployable step 282. The operator OP may then raise their first foot from the deployable step 280 onto the closest control panel step 292, supporting their weight on the control panel step 292. The operator OP may then raise their second foot from the deployable step 282 into the monitor compartment 230. Once within the monitor compartment 230, the operator OP may move freely throughout the top side 206 of the body 52, accessing the top compartments 220, the monitor 232, and the hose bed compartment 240. A similar process may be followed in reverse to descend from the top side 206 of the body 52 back to the operator support surface 104.

### Linkages Between Control Levers and Control Valves

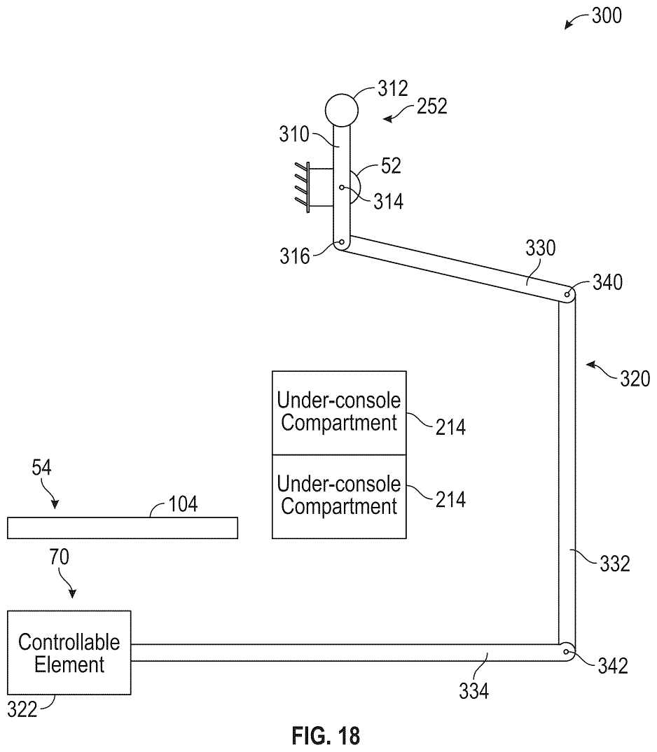

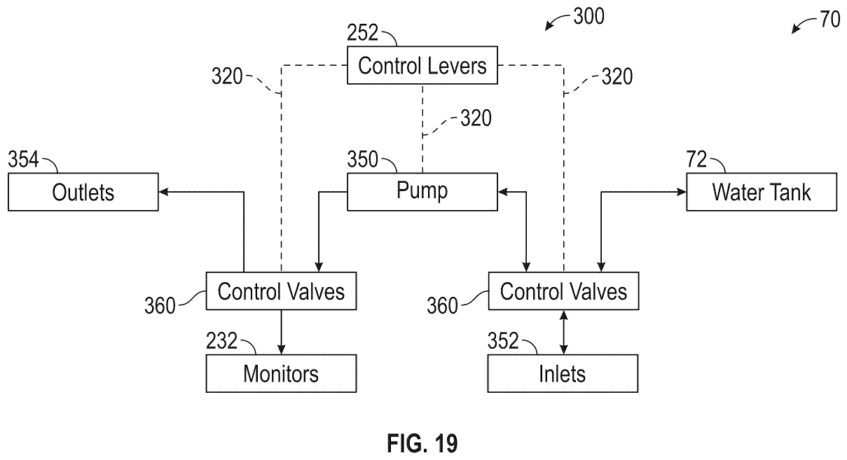

Referring to FIGS. 18 and 19, linkage assemblies 300 for one of the control levers 252 are shown according to an exemplary embodiment. Each of the control levers 252 may utilize a similar linkage assembly 300 to connect the control lever 252 to a corresponding controlled component, such as a valve of the pump system 70. The linkage assemblies 300 shown in FIGS. 18 and 19 may couple the control levers 252 to corresponding the controlled components without requiring an electronic connection (e.g., purely mechanically, without transferring an electrical signal, etc.).

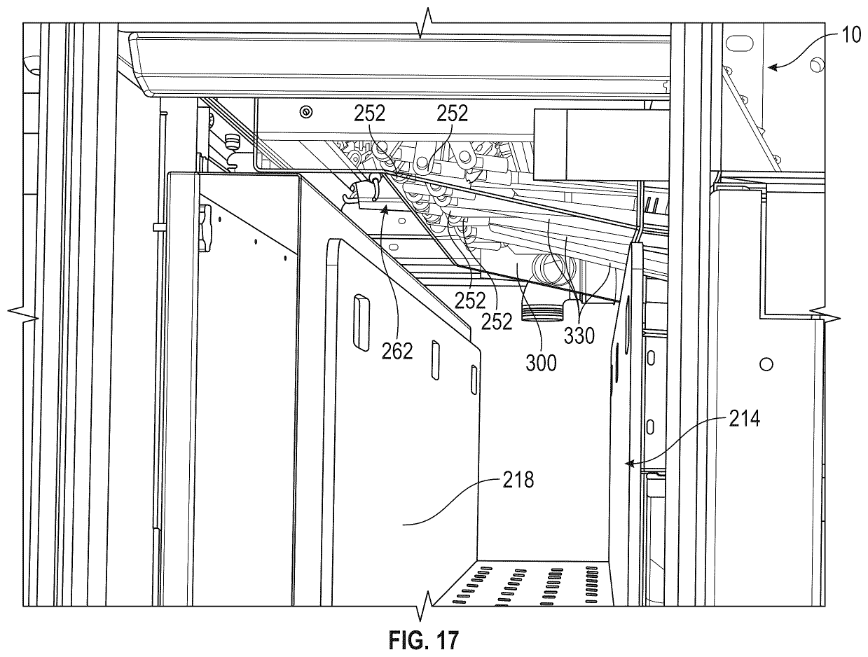

FIG. 17 illustrates the control levers 252 as viewed from within the upper of the two under-console compartments 214. The control levers 252 are arranged in a laterally-extending row, each control levers 252 having a similar vertical position and longitudinal position. As shown, the control levers 252 extend downward, through the linkage passage 262, and directly above the under-console compartments 214. Accordingly, the control levers 252 may be accessed from the front side 200 of the body 52 (e.g., by an operator within the operator compartment 58) by removing the front door 218. This may facilitate maintenance of the control levers 252 and components coupled to the control levers 252 (e.g., the control linkages 320). In some embodiments, the control levers 252 are directly exposed to the under-console compartments 214. In other embodiments, a removable barrier extends between the control levers 252 and the under-console compartments 214.

Referring to FIG. 18, a connection to a single control lever 252 is shown. It should be understood that the other control levers 252 may utilize similar connections. The control lever 252 includes a linkage or lever, shown as lever body 310, and an interface element or grip, shown as knob 312. The lever body 310 may be a rigid member. The knob 312 is coupled to an upper end of the lever body 310 and provides a handle for the operator OP to engage with their hand. The lever body 310 is pivotably coupled to the body 52, such that the lever body 310 is rotatable about a first pivot point or lateral axis of rotation, shown as axis 314. A second pivot point or lateral axis of rotation, shown as axis 316, extends through a bottom end portion of the lever body 310.

The linkage assemblies 300 includes a mechanical coupler or linkage assembly, shown as control linkage 320, that couples each of the control levers 252 to a controllable element, device, mechanism, component, or assembly, shown as controllable element 322. Each of the control levers 252 may have a corresponding control linkage 320 and a corresponding controllable element 322. In response to a movement of a control lever 252, the control linkage 320 may cause a corresponding movement of the controllable element 322. Accordingly, the control linkage 320 permits control over the controllable element 322 by the control lever 252.

The control linkage 320 includes a series of links, rigid members, or hardline pipes, shown as longitudinal link 330, upright link 332, and longitudinal link 334. The longitudinal link 330 extends longitudinally between the lever body 310 and the upright link 332. The upright link 332 extends vertically between the longitudinal link 330 and the longitudinal link 334. The longitudinal link 334 extends longitudinally between the upright link 332 and the controllable element 322.

In some embodiments, each of the longitudinal link 330, the upright link 332, and the longitudinal link 334 are rigid members, such that the longitudinal link 330, the upright link 332, and the longitudinal link 334 maintain substantially the same shape and transfer force under tensile, compressive, and bending loads. In contrast, a flexible member such as a cable or rope may deform under non-tensile loads. By selecting rigid members for the longitudinal link 330, the upright link 332, and the longitudinal link 334, the control linkage 320 may have a predetermined range of motion that transfers repeatable and predictable motion between the control lever 252 and the controllable element 322.

A first end portion (e.g., a forward end portion) of the longitudinal link 330 is pivotably coupled to the lever body 310, such that the longitudinal link 330 is rotatable relative to the lever body 310 about the axis 316. A second end portion (e.g., a rear end portion) of the longitudinal link 330 is pivotably coupled to a first end portion (e.g., a top end portion) of the upright link 332. The longitudinal link 330 is rotatable relative to the upright link 332 about a pivot point or lateral axis of rotation, shown as axis 340. A second end portion (e.g., a bottom end portion) of the upright link 332 is pivotably coupled to a first end portion (e.g., a rear end portion) of the longitudinal link 334. The upright link 332 is rotatable relative to the longitudinal link 334 about a pivot point or lateral axis of rotation, shown as axis 342. In other embodiments, the longitudinal link 330, the upright link 332, and the longitudinal link 334 are fixedly coupled to one another. By way of example, the longitudinal link 330, the upright link 332, and the longitudinal link 334 may be formed as a single, continuous piece (e.g., by bending a rod or tubular member).

The linkage assembly 300 may control operation of any controllable element, device, mechanism, component, or assembly. When the lever body 310 is moved by the operator OP, the control lever 252 causes a corresponding movement of the linkage assembly 300, which in turn causes a corresponding movement of the controllable element 322. By way of example, when the operator moves the knob 312 to the right as shown in FIG. 18 (e.g., a rearward direction relative to the frame 12), the lever body 310 moves the axis 316 to the left, which in turn causes a corresponding leftward (e.g., forward) movement of the longitudinal link 330, the upright link 332, and the longitudinal link 334. The longitudinal link 334 moves a portion of controllable element 322 to control operation of the controllable element 322. The operator OP may move the knob 312 in the opposite direction (e.g., to the left as shown in FIG. 18) to cause a corresponding reverse movement of the portion of the controllable element 322. In this way, each position of the control levers 252 may have a corresponding position and operating condition of the controllable element 322.

Referring to FIG. 19, the control levers 252 and the linkage assemblies 300 may be used to control operation of one or more elements of the pump system 70. As shown, the pump system 70 includes a fluid pump or impeller, shown as pump 350. The pump 350 is configured to receive a fluid (e.g., water, a fire suppressing agent, a foam, or a mixture thereof) at a relatively low pressure (e.g., atmospheric pressure, pressure at a fire hydrant, etc.) and provide a flow of the fluid at a relatively high pressure. The pump 350 may receive the fluid from the water tank 72 and/or through one or more inlets 352. The pump 350 may provide or distribute the pressurized fluid to one or more monitors 232 of the fire apparatus 10 and/or through one or more outlets 354. In some embodiments, the pump 350 is configured to provide the fluid to the water tank 72 to refill the water tank 72 from an external source of the fluid.

The inlets 352 may each represent an aperture or passage through which the fluid may be supplied to the fire apparatus 10. By way of example, an inlet 352 may be fluidly coupled to an external source of the fluid through a hose, pipe, or other conduit. The external source may include a body of water (e.g., a lake, a river, an ocean, etc.), a stationary tank (e.g., water tank), a tank transported by another vehicle (e.g., a tanker truck), a fire hydrant, or another source. The fire apparatus 10 may include multiple inlets 352 to facilitate drawing the fluid from multiple different sources (e.g., simultaneously or at different times).

The outlets 354 may reach represent an aperture or passage through which the fluid may be provided, distributed, expelled, or otherwise removed from the fire apparatus 10. By way of example, an outlet 354 may be fluidly coupled to an external recipient of the fluid through a hose, pipe, or other conduit. The external recipient may include another vehicle (e.g., a fire apparatus, a tanker truck, etc.), a handheld nozzle, a stationary tank, or another recipient. The fire apparatus 10 may facilitate suppressing, extinguishing, or otherwise fighting a fire by supplying the flow the pressurized fluid through the monitors 232 and/or the outlets 354 to be sprayed onto or near a fire.

The pump 350 may be fluidly coupled to the water tank 72, the inlets 352, the outlets 354, and/or the monitors 232 through one or more controllable elements, shown as control valves 360. The control valves 360 may control the flow rate (e.g., open and close to selectively prevent flow, gradually meter flow, etc.), vary the direction of flow, or otherwise control the flow of the fluid into, through, and out of the pump system 70. The control valves 360 may include shutoff valves, flow control valves, directional control valves, or any other type of valve.

The control levers 252 may be coupled to the pump 350 and the control valve 360 by the linkage assemblies 300. Each control lever 252 may be assigned to a different function (e.g., pump speed, opening or closing a particular control valve 360, etc.). By locating all of the control levers 252 at the control panel 56 and coupling the control levers 252 to the pump system 70 through the linkage assemblies 300, the operator OP may be provided with complete control over the pump system 70 from one location.

As shown, a linkage assembly 300 may couple a control lever 252 to the pump 350, such that the control lever 252 may control operation of the pump 350 through a control linkage 320. In response to a movement of the control linkage 320, the pump 350 may vary one or more of its operating characteristics (e.g., pump speed, flow rate, pump pressure, etc.). By way of example, a control lever 252 coupled to the pump 350 by the control linkage 320 may be movable throughout a range of motion from a first position (e.g., a frontmost position) to a second position (e.g., a rearmost position). Each position throughout the range of motion may correspond to a different level of the operating characteristic (e.g., a different pump speed, a different pump pressure, etc.). By way of example, the first position may command the pump 350 to operate at a minimum pump speed (e.g., off), and the second position may command the pump 350 to operate at a maximum pump speed. Accordingly, the control levers 252 may facilitate control over operation of the pump 350 by the operator positioned within the operator compartment 58.

Similarly, a linkage assembly 300 may couple a control lever 252 to one or more of the control valves 360, such that the control lever 252 may control operation of the one or more control valves 360 through a control linkage 320. A control valve 360 may selectively limit a flow of a fluid (e.g., water) through the control valve 360. A longitudinal link 334 of the control linkage 320 may be coupled to a valve element (e.g., a spool, a gate, a ball, etc.) that moves to selectively limit the flow of the fluid through the control valve. By way of example, a control lever 252 coupled to a control valve 360 by a control linkage 320 may be movable throughout a range of motion from a first position (e.g., a frontmost position) to a second position (e.g., a rearmost position). Each position throughout the range of motion may correspond to a different position of the valve element, and thus a different flow rate or flow direction through the control valve 360. By way of example, the first position may command the control valve 360 to operate at a minimum flow rate (e.g., closed), and the second position may command the control valve 360 to permit maximum flow through the control valve 360. Accordingly, the control levers 252 may facilitate control over operation of the control valves 360 by the operator positioned within the operator compartment 58.

Referring again to FIG. 18, the shape of the linkage assemblies 300 provides space for the under-console compartments 214. As shown, each control linkage 320 forms a C-shape that extends around the under-console compartments 214 to connect the control levers 252 to the corresponding controllable elements 322. Specifically, the longitudinal link 330 extends longitudinally rearward (e.g., in a first horizontal direction) from the control lever 252, the upright link 332 extends downward (e.g., in an upright or vertical direction) from the longitudinal link 330, and the longitudinal link 334 extends longitudinally forward (e.g., in a second horizontal direction) from the upright link 332 to the controllable element 322. The rigid structure of each of the longitudinal link 330, the upright link 332, and the longitudinal link 334 permits the control linkage 320 to hold this shape without buckling under load.

By extending the control linkage 320 around the under-console compartments 214, the under-console compartments 214 can extend unobstructed between the left and right sides of the fire apparatus 10, forming a continuous storage compartment. If the control linkage 320 were instead to extend straight from the control lever 252 to the controllable element 322, the control linkage 320 would extend through the space occupied by the under-console compartments 214. Additionally, extending behind the under-console compartments 214 as opposed to in front of the under-console compartments 214 prevents the control linkage 320 from occupying space within the operator compartment 58, giving the operator OP additional room to move.

### Pump System Layout

Referring to FIG. 5-7 and 20-22, the layout of the pump system 70 is shown, according to an exemplary embodiment. The pump system 70 generally extends beneath a rear end portion of the front cabin 40, the platform assembly 54, and a front end portion of the body 52. In some embodiments, the pump system 70 is substantially centered along the length of the fire apparatus 10. The pump system 70 extends laterally across the entire fire apparatus 10, from the left side to the right side of the fire apparatus 10. Accordingly, the pump system 70 may be accessible from both the right side and the left side of the fire apparatus 10.

The pump system 70 includes a pair of manifolds or fittings, shown as inlet fittings 400, coupled to the frame 12 and defining one or more of the inlets 352. The inlet fittings 400 may include a coupling structure (e.g., a threaded connection, studs, seals, etc.) that facilitate selectively fixedly and fluidly coupling the inlets 352 to external conduits (e.g., fire hoses). As shown, each inlet fitting 400 defines multiple inlets 352 of different sizes. This may facilitate compatibility with conduits of different sizes, which may facilitate coupling the pump system 70 with different types of external sources having different flow rates.

As shown, the pump system 70 includes one inlet fitting 400 positioned on the right side of the fire apparatus 10 and one inlet fitting 400 positioned on the left side of the fire apparatus 10. Accordingly, the inlets 352 face laterally outward and in opposing directions. The inlets 352 are thus accessible from each lateral side of the fire apparatus 10 (e.g., the left side and the right side). This arrangement of the inlet fittings 400 permits connecting to external sources on each lateral side of the fire apparatus 10. This may prevent the need to reorient the fire apparatus 10, reposition the external source, or run a hose around the fire apparatus 10 to make a connection between the external source of fluid and the pump system 70.

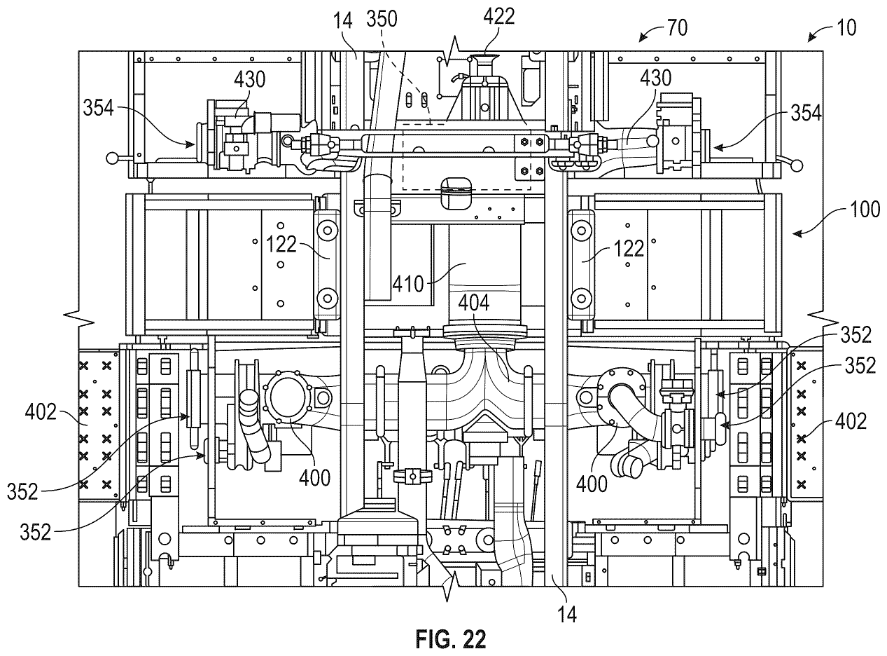

The inlet fittings 400 are positioned beneath the control panel 56 and below the operator support surface 104. The inlet fittings 400 are positioned rearward of the platform assembly 54. As shown in FIGS. 20 and 22, a support, shown as step 402, is positioned beneath each of the inlet fittings 400. The steps 402 are fixedly coupled to the frame 12. The steps 402 may be configured to support a user to facilitate access to the side compartments 210 and/or the under-console compartments 214. By way of example, a user may stand on a step 402 when reaching into a side compartment 210 or an under-console compartment 214.

As shown in FIG. 22, the pump system 70 further includes a junction, Y fitting, or T fitting, shown as junction 404. The junction 404 fluidly couples to both of the inlet fittings 400, such that the junction 404 unites the flows of fluid from all of the inlets 352. As shown, the junction 404 includes a pair of inlet legs, each inlet leg being fluidly coupled to one of the inlet fittings 400, and an outlet leg extending forward from the inlet legs. The inlet legs extend laterally and the outlet leg extends longitudinally, such that the junction 404 forms a Y shape or T shape. The junction 404 may define passages that gradually transition from a lateral orientation to a longitudinal orientation to redirect the fluid without resisting fluid flow through the junction 404. The junction 404 is positioned beneath the control panel 56 and rearward of the platform assembly 54.

Referring to FIG. 5, the junction 404 may define a third inlet leg that is fluidly coupled to the water tank 72 through a conduit, shown as pipe 406. The pipe 406 extends longitudinally from the water tank 72 to the junction 404 and couples with a rear central portion of the junction 404. Accordingly, the junction 404 may further fluidly couple the inlets 352 with the water tank 72.

Referring to FIG. 5-7 and 20-22, the pump system 70 further includes a coupler, connector, or extension, shown as pipe extension 410, that extends longitudinally between the junction 404 and the pump 350 beneath the platform assembly 54. As shown, the pump 350 is positioned forward of the platform assembly 54, below the operator support surface 104, and beneath the rear end portion of the front cabin 40. Accordingly, the pump 350 is longitudinally offset forward of the junction 404. The pipe extension 410 extends longitudinally forward from the junction 404 to the pump 350, fluidly coupling the outlet leg of the junction 404 to an inlet of the pump 350. The pipe extension 410 longitudinally offsets the pump 350 from the junction 404, providing space for the platform assembly 54 to extend between the pump 350 and the junction 404.

As shown, the pump 350 defines a pair of outlet passages, shown as pump outlets 420. The pump outlets 420 face outward from the pump 350 in opposing lateral directions (e.g., left and right). The pump 350 includes a rotational mechanical energy input, coupler, or interface, shown as input shaft 422, positioned along a front side of the pump 350. The input shaft input shaft 422 may be coupled to the prime mover 80 through the drive shaft 84 to receive rotational mechanical energy from the prime mover 80. In response to rotation of the input shaft 422, the pump 350 may draw in fluid from the pipe extension 410 and expel pressurized fluid through both of the pump outlets 420. In some embodiments, the pump 350 is a centrifugal pump. In some embodiments, the pump 350 is capable of supplying at least 200 gallons per minute (“gpm”) of the fluid.

The pump system 70 includes a pair of manifolds or fittings, shown as outlet fittings 430, coupled to the frame 12 and defining one or more of the outlets 354. Each of the outlet fittings 430 is fixedly and fluidly coupled to one of the pump outlets 420, such that fluid from the pump 350 may be expelled through the outlet fittings 430. The outlet fittings 430 may include a coupling structure (e.g., a threaded connection, studs, seals, etc.) that facilitate selectively fixedly and fluidly coupling the outlets 354 to external conduits (e.g., fire hoses). As shown, each outlet fitting 430 defines multiple outlets 354 of different sizes. This may facilitate compatibility with conduits of different sizes, which may facilitate coupling the pump system 70 with different types of external receivers. In some embodiments, the pump system 70, in addition to or in place of one of the outlet fittings 430, includes a conduit extending from one of the pump outlets 420 to the monitor 232.

As shown, the pump system 70 includes one outlet fitting 430 positioned on the right side of the fire apparatus 10 and one outlet fitting 430 positioned on the left side of the fire apparatus 10. Accordingly, the outlets 354 face laterally outward and in opposing directions. The outlets 354 are thus accessible from each lateral side of the fire apparatus 10 (e.g., the left side and the right side). This arrangement of the outlet fittings 430 permits connecting to external sources on each lateral side of the fire apparatus 10. This may prevent the need to reorient the fire apparatus 10, reposition the external source, or run a hose around the fire apparatus 10 to make a connection between the pump system 70 and an external receiver of the fluid. The outlet fittings 430 are positioned beneath the front cabin 40 and below the operator support surface 104. The outlet fittings 430 are positioned forward of the platform assembly 54.

During operation of the fire apparatus 10, the prime mover 80 may drive the pump 350 through the drive shaft 84 and the input shaft 422, such that the pump 350 draws in fluid from the pipe extension 410. Fluid may flow into the fire apparatus 10 through the inlets 352, flow through the inlet fittings 400, the junction 404, and the pipe extension 410, and reach the inlet of the pump 350. Similarly, fluid may flow from the water tank 72, flow through the pipe 406, the junction 404, and the pipe extension 410, and reach the inlet of the pump 350. The pump 350 may pressurize the fluid and discharge the pressurized fluid through the pump outlets 420 and the outlet fittings 430 and out through the outlets 354.

The arrangement of the pump system 70 relative to the other components of the fire apparatus 10 may extend around other components of the fire apparatus 10 to make the fire apparatus 10 more compact. As shown, the inlet fittings 400, the junction 404, and the inlets 352 are offset longitudinally rearward from the pump 350, the outlet fittings 430, and the outlets 354, such that the pump system 70 wraps around the platform assembly 54. Accordingly, the inlets 352 are separated from the outlets 354 by the ladder assemblies 102 (e.g., the ladder assemblies 102 extend between the inlets 352 and the outlets 354). This arrangement exposes the inlets 352 and the outlets 354 along the sides of the vehicles while still accommodating the space claim of the ladder assemblies 102. This arrangement is facilitated by the addition of the pipe extension 410 to longitudinally offset the front and rear portions of the pump system 70.

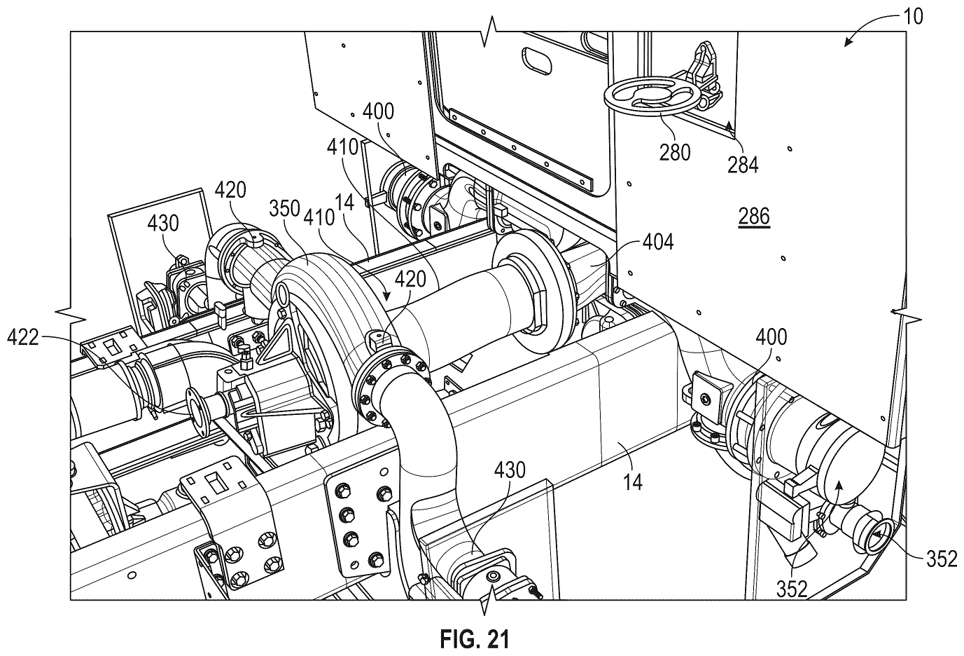

As shown in FIG. 21, the pump 350, the pipe extension 410, and the junction 404 are substantially laterally centered between the frame rails 14 (e.g., positioned along a longitudinal centerline of the fire apparatus 10) and extend above the top surfaces of the frame rails 14. The inlet fittings 400 and the outlet fittings 430 extend laterally outward from the junction 404 and the pump 350, respectively, and extend downward after extending outside of the frame rails 14. This arrangement permits the pump system 70 to pass over the frame rails 14 (e.g., without requiring passthrough holes that could weaken the frame rails 14) while still permitting the inlets 352 and the outlets 354 to be positioned beneath the body 52 and the front cabin 40, respectively.

Advantageously, the placement of the front cabin 40, the body 52, the platform assembly 54, the control panel 56, and the pump system 70 may facilitate maximizing the storage capacity of the fire apparatus 10 without increasing or while minimizing a length of the fire apparatus 10. In some embodiments, the fire apparatus 10 has a total storage volume of at least about 384 ft³ (e.g., at least 346 ft³, at least 384 ft³). The storage volume may include, for example, the combined storage volumes of the front cabin 40, the side compartments 210, the under-console compartments 214, the top compartments 220, the monitor compartment 230, the hose bed compartment 240, and any other storage compartments of the fire apparatus 10. In some embodiments, the fire apparatus 10 has an overall length (e.g., measured longitudinally) of about 390.5 in. In some embodiments, the fire apparatus 10 has a wheel base (e.g., a longitudinal distance between the center of the front axle 30 and the center of the rear axle 32) of about 199.5 in.

### Alternative Ladder Configuration

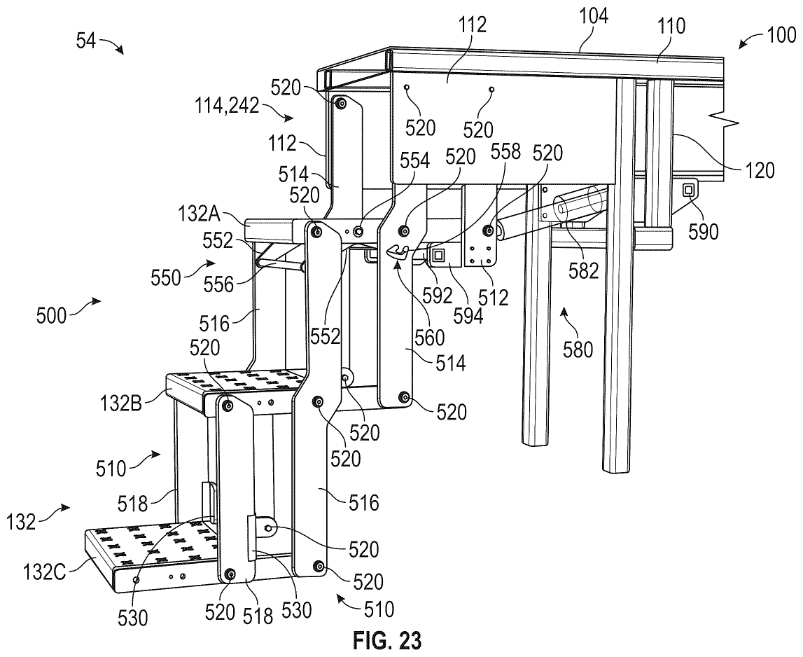

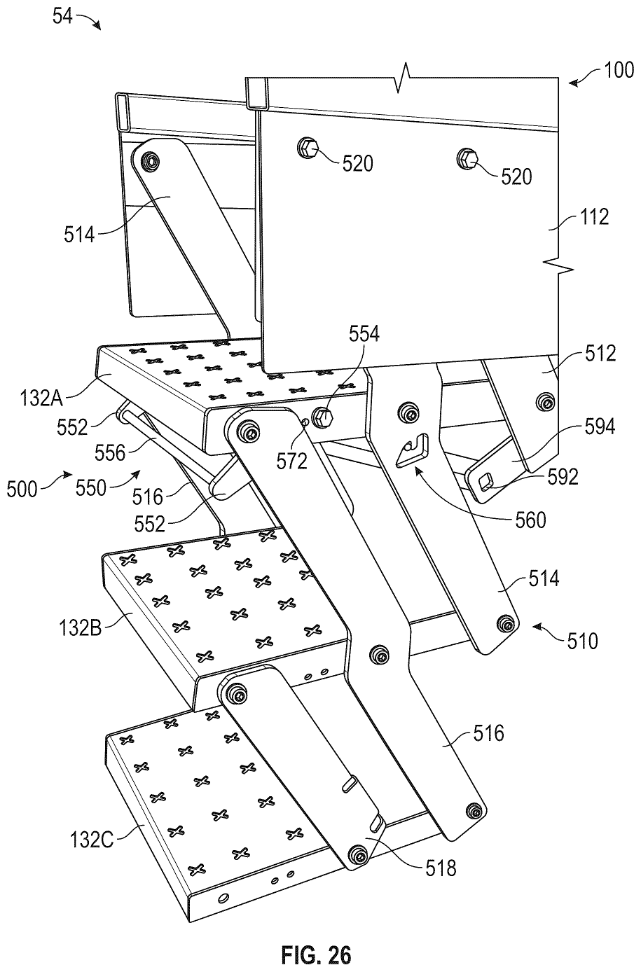

Referring to FIG. 23-32, the platform assembly 54 is shown according to an alternative embodiment. In this embodiment, the platform assembly 54 includes a pair of deployable access assemblies, ladders, stairs, or steps, shown as ladder assemblies 500, coupled to the platform frame 100 in place of the ladder assemblies 102. The ladder assemblies 500 may be substantially similar to the ladder assemblies 102 and may be positioned similarly to the ladder assemblies 102, except as otherwise specified herein. The platform assembly 54 includes one ladder assembly 500 positioned on the left side of the fire apparatus 10, and another ladder assembly 500 positioned on the right side of the fire apparatus 10. Accordingly, while FIG. 23-32 may illustrate a single ladder assembly 500, it should be understood that any description of one ladder assembly 500 may also apply to the other the ladder assembly 500.

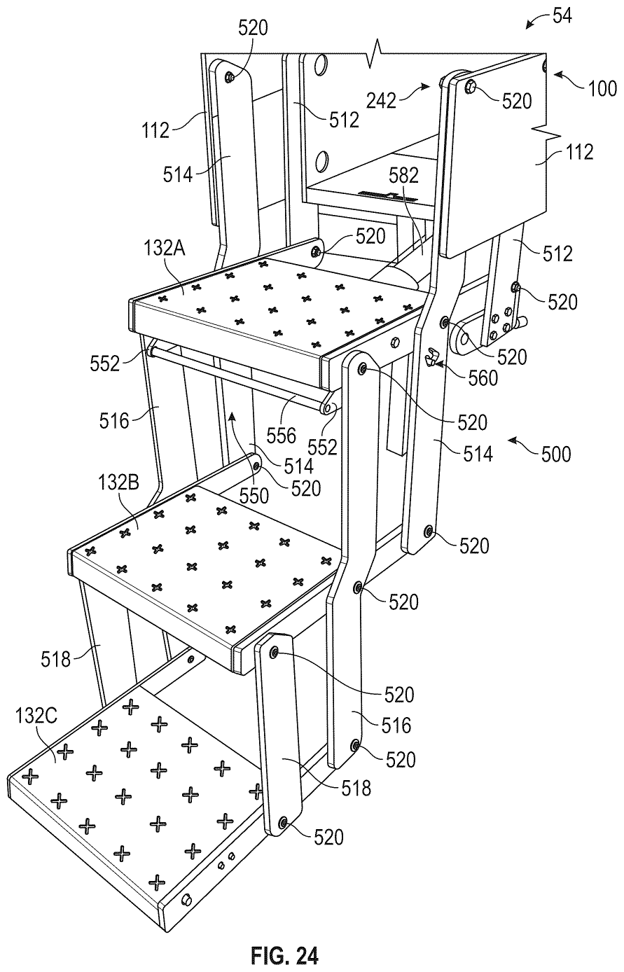

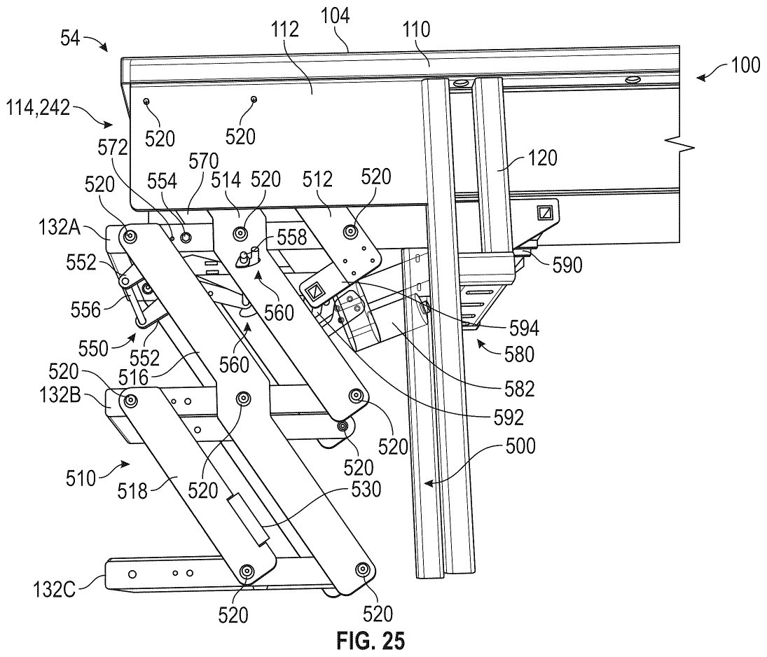

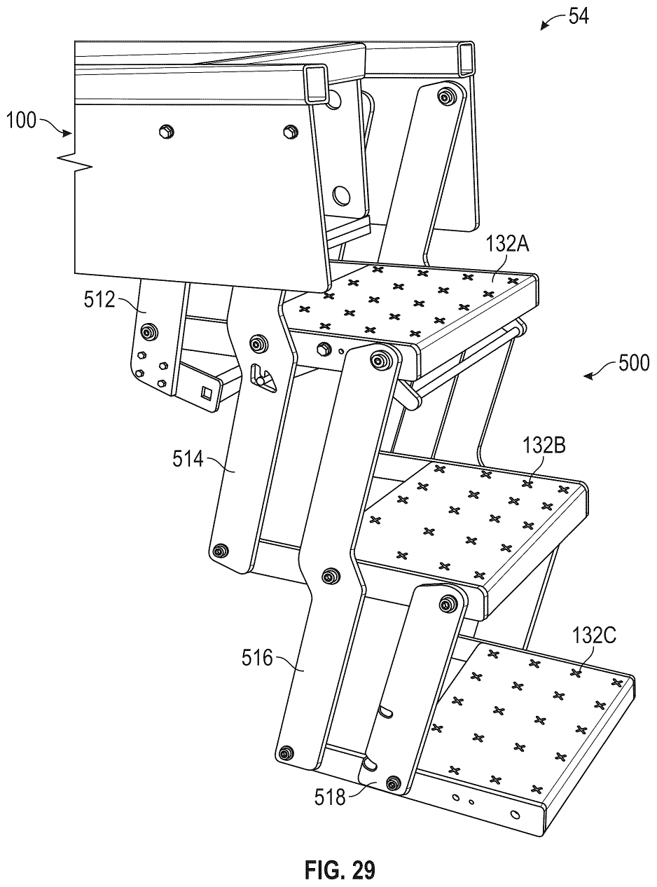

Each ladder assembly 500 is movably coupled to the platform frame 100, such that the ladder assemblies 500 are each repositionable between a stored position (shown in FIG. 25-27) and a deployed position (shown in FIGS. 23 and 24). In the stored position, the ladder assemblies 500 are collapsed, taking up a relatively smaller volume of space and retracting upward and laterally inward into the ladder recesses 114. In the deployed position, the ladder assemblies 500 are expanded, taking up a relatively larger volume of space and extending downward and laterally outward from the platform frame 100 to facilitate access to the operator support surface 104 by the operator OP (e.g., facilitating climbing from the ground or a ground surface onto the operator support surface 104). The configuration of FIGS. 23 and 24 may represent a fully deployed position, and the positions between the fully deployed position and the stored position (e.g., the position of FIG. 29) may represent partially deployed positions. In some embodiments, the ladder assemblies 500 are only used to support the operator OP in the fully deployed position. In other embodiments, the ladder assemblies 500 also support the operator OP in the partially deployed positions.

As shown in FIG. 23-30 and 32, each ladder assembly 500 includes a series of longitudinal members, stairs, steps, or rungs, shown as steps 132. Specifically, the steps 132 include a first or uppermost step, shown as top step 132A, a second or intermediate step, shown as middle step 132B, and a third or lowermost step, shown as bottom step 132C. The top step 132A is positioned above the middle step 132B, and the bottom step 132C is positioned below the middle step 132B. The steps 132 each extend longitudinally. Each step 132 has a top surface that is configured to support a foot or a hand of the operator OP to facilitate the operator OP scaling the ladder assembly 500 and accessing the operator support surface 104. Although the ladder assembly 500 is shown with three steps 132, in other embodiments the ladder assemblies 500 includes include more or fewer steps 132.

As shown in FIG. 23-27, the ladder assemblies 500 includes a pair of linkage assemblies, shown as stair linkages 510. The stair linkages 510 are positioned on opposing longitudinal sides (e.g., forward and rearward sides) of the steps 132. The stair linkages 510 may be symmetrically arranged about the longitudinal center of the steps 132. The stair linkages 510 movably couple the steps 132 to the platform frame 100, permitting the steps 132 to move through a predetermined range of motion. In some embodiments, the stair linkages 510 constrain the motion of the steps 132 to maintain a constant (e.g., horizontal) orientation of the steps 132 throughout the range of motion. By way of example, each position of the stair linkages 510 may have a corresponding, predetermined set of positions for the steps 132.

As shown in FIG. 23-27, the stair linkages 510 each include a series of linkages, couplers, or bars, shown as rear upper link 512, front upper link 514, rear lower link 516, and front lower link 518. The rear upper link 512, the front upper link 514, the rear lower link 516, and the front lower link 518 of each stair linkage 510 occupy a common lateral and vertical plane (e.g., are coplanar). The rear upper link 512, the front upper link 514, the rear lower link 516, and the front lower link 518 are positioned longitudinally between the side panels 112 and longitudinally outside of the steps 132.

As shown in FIG. 23-27, the rear upper link 512, the front upper link 514, the rear lower link 516, and the front lower link 518 are each pivotably coupled to the side panels 112 and/or the steps 132 by a series of pivoting couplers, shown as joints 520. Each joint 520 permits partial rotation between the components coupled by the joint 520. The joints 520 may limit (e.g., prevent) other movement between the components (e.g., longitudinal translation, etc.). Each joint 520 defines a corresponding longitudinal axis of rotation that passes through the center of the joint 520. Pairs of joints 520 from each stair linkage 510 are aligned with one another, such that the joints 520 permit rotation about a common axis of rotation. By way of example, a first joint 520 couples the top step 132A to the rear lower link 516 of the first stair linkage 510, and a second joint 520 aligned with the first joint 520 couples the top step 132A to the rear lower link 516 of the second stair linkage 510. In some embodiments, each joint 520 includes a pin or fastener that extends through a link and either a step 132 or a side panel 112 to form a pivoting connection.

As shown in FIG. 23-27, an upper end portion of each rear upper link 512 is pivotably coupled to a side panel 112 by a joint 520. A lower end portion of the rear upper link 512 is pivotably coupled to a laterally inward end portion of the top step 132A by a joint 520. Accordingly, the rear upper link 512 is pivotably coupled to the side panel 112 and the top step 132A.

As shown in FIG. 23-27, an upper end portion of each front upper link 514 is pivotably coupled to a side panel 112 by a joint 520. An intermediate or middle portion of the front upper link 514 is pivotably coupled to an intermediate or middle portion of the top step 132A by a joint 520. A lower end portion of the front upper link 514 is pivotably coupled to a laterally inward end portion of the middle step 132B by a joint 520. Accordingly, the front upper link 514 is pivotably coupled to the side panel 112, the top step 132A, and the middle step 132B.

As shown in FIG. 23-27, an upper end portion of each rear lower link 516 is pivotably coupled to a laterally outward portion of the top step 132A by a joint 520. An intermediate or middle portion of the rear lower link 516 is pivotably coupled to an intermediate or middle portion of the middle step 132B by a joint 520. A lower end portion of the rear lower link 516 is pivotably coupled to a laterally inward end portion of the bottom step 132C by a joint 520. Accordingly, the rear lower link 516 is pivotably coupled to the top step 132A, the middle step 132B, and the bottom step 132C.

As shown in FIG. 23-27, an upper end portion of each front lower link 518 is pivotably coupled to a laterally outward portion of the middle step 132B by a joint 520. A lower end portion of the front lower link 518 is pivotably coupled to an intermediate or middle portion of the bottom step 132C by a joint 520. Accordingly, the front lower link 518 is pivotably coupled to the middle step 132B and the bottom step 132C.

As shown in FIGS. 23 and 24, the upper end portions of the rear upper links 512 and the front upper links 514 are overlapped by the side panels 112. This causes the rear upper links 512 and the front upper links 514 to press against inner surfaces of the side panels 112. This engagement causes the side panels 112 to limit longitudinal movement of the rear upper links 512 and the front upper links 514, increasing stability of the ladder assembly 500.

As shown in FIG. 23-27, each of the front lower links 518 includes a protrusion or flange, shown as stop flange 530. The stop flange 530 of each front lower link 518 extends longitudinally toward the other front lower link 518, such that the stop flanges 530 at least partially overhang the bottom step 132C (e.g., the bottom step 132C extends beneath the stop flange 530). When the ladder assembly 500 is in the stored position of FIG. 25-27, the stop flange 530 are spaced from the bottom step 132C, permitting relative motion between the bottom step 132C and the front lower link 518. When the ladder assembly 500 is extended to the fully deployed position of FIGS. 23 and 24, the stop flanges 530 each engage a top surface of the bottom step 132C, preventing further extension of the ladder assembly 500. Accordingly, the stop flanges 530 limit extension of the ladder assembly 500 beyond the fully deployed position.

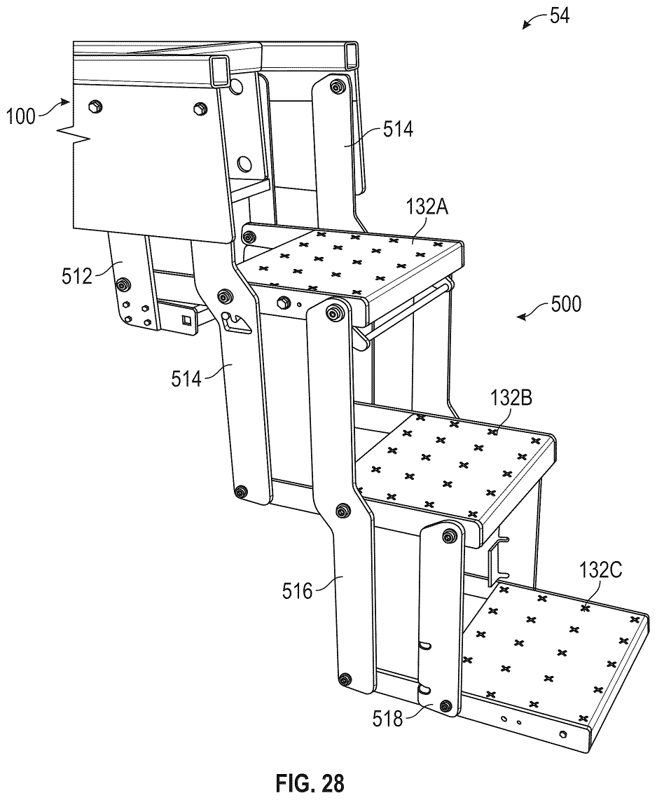

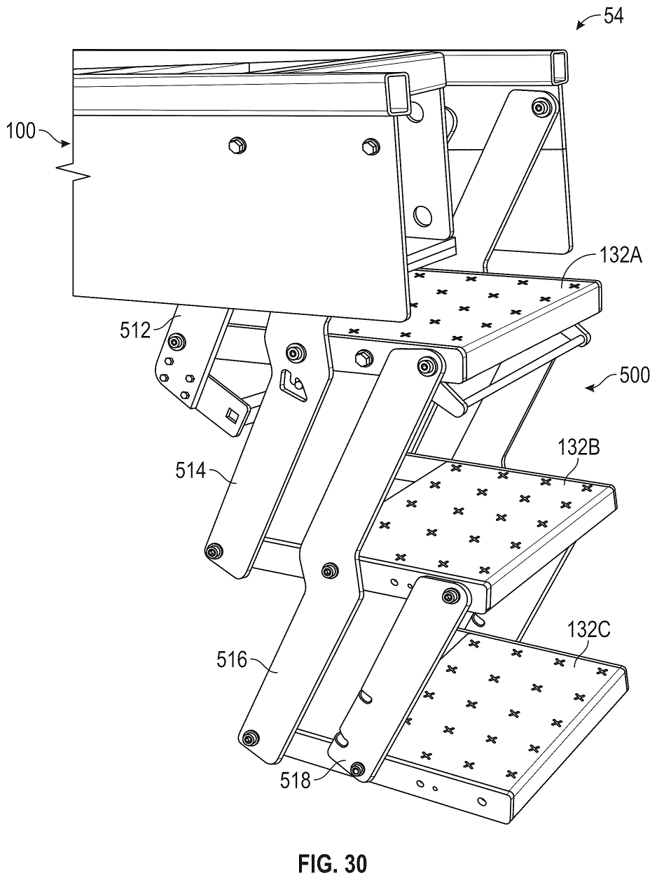

Referring to FIG. 28-30, the range of motion of the ladder assembly 500 is shown according to an exemplary embodiment. Specifically, FIG. 28-30 show the ladder assembly 500 being retracted from the fully deployed position (e.g., FIG. 28), to a partially deployed position (e.g., FIG. 29), to a stored position (e.g., FIG. 30). The rear upper link 512 and the front upper link 514 act as a four-bar linkage between the side panels 112 and the top step 132A, holding the top step 132A horizontal throughout the range of motion. The front upper link 514 and the rear lower link 516 act as a four-bar linkage between the top step 132A and the middle step 132B, holding the middle step 132B horizontal throughout the range of motion. The rear lower link 516 and the front lower link 518 act as a four-bar linkage between the middle step 132B and the bottom step 132C, holding the bottom step 132C horizontal throughout the range of motion. Because the front upper link 514 and the rear lower link 516 extend between multiple of these four-bar linkage arrangements, the stair linkages 510 coordinate the motion of all of the steps 132 together.

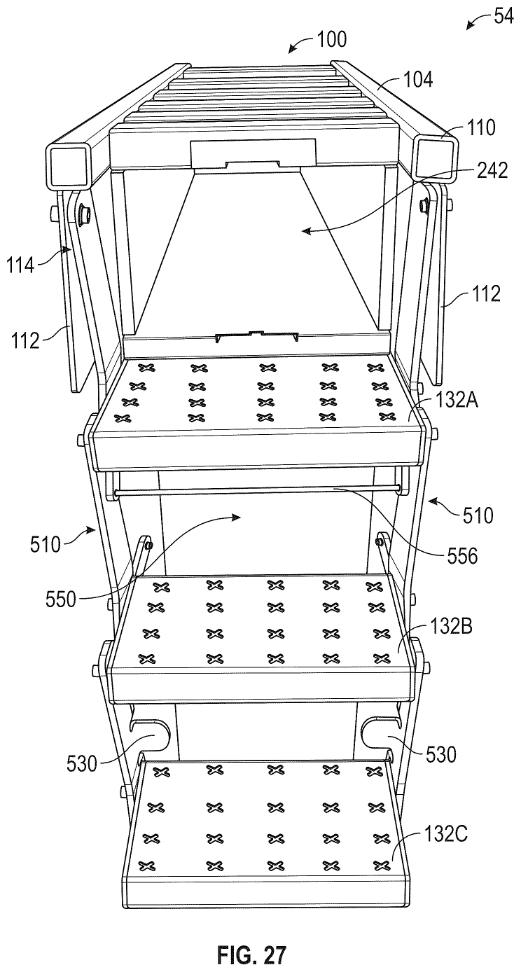

As shown in FIGS. 24 and 27, the top step 132A is positioned below the under-walkway compartment 242 throughout the range of motion of the ladder assembly 500. Additionally, the stair linkages 510 are each longitudinally offset from the under-walkway compartment 242. Accordingly, the ladder assembly 500 does not obstruct the under-walkway compartment 242 at any point throughout the range of motion of the ladder assembly 500. Beneficially, the ladder assembly 500 ensures that items within the under-walkway compartment 242 can be accessed at any time, regardless of whether the ladder assembly 500 is being used (e.g., how far the ladder assembly 500 is currently extended) or not.

Referring to FIG. 23-27 and 31, the ladder assembly 500 includes a lock, latch, or mechanical position control, shown as latch assembly 550. The latch assembly 550 selectively limits (e.g., prevents) movement of the ladder assembly 500. Specifically, the latch assembly 550 selectively holds the latch assembly 550 in the storage position and the fully deployed position. The latch assembly 550 may be manually engaged or disengaged by the operator OP to control movement of the ladder assembly 500.

As shown in FIG. 23-27 and 31, the latch assembly 550 includes a pair of main portions or bodies, shown as arms 552. The arms 552 are each pivotably coupled to the top step 132A by a pivoting coupler, shown as joint 554. The joints 554 may be similar in construction to the joints 520. The joints 554 are aligned with one another, such that the joints 554 permit rotation of the arms 552 about a common longitudinal axis of rotation that is centered about the joints 554. The joints 554 are positioned near the middle of the arms 552, such that the arms 552 act as a first-class lever.

As shown in FIG. 23-27 and 31, the latch assembly 550 further includes a cross member, interface, or bar, shown as handle 556, that extends longitudinally between the arms 552. The handle 556 is fixedly coupled to a laterally outward end portion of each arm 552, fixedly coupling the arms 552 to one another. The handle 556 serves as an interface for an operator OP to grab and interact with the latch assembly 550. An operator OP may lift or lower the handle 556 to disengage or engage the latch assembly 550.

As shown in FIG. 23-27 and 31, the latch assembly 550 further includes a cam member, pin, guide, or interface member, shown as guide pin 558, that extends longitudinally between the arms 552 and outward from each arm 552 toward the front upper link 514. Each front upper link 514 defines a groove, recess, slot, aperture, passage, or cutout, shown as guide slot 560, that receives the guide pin 558. As shown, the guide slot 560 extends through the entirety of the front upper link 514. In other embodiments, the guide slot 560 extends only partway through the front upper link 514. By way of example, the front upper link 514 may include a boss that defines the guide slot 560. The guide pin 558 engages the walls of the guide slot 560 to control motion of the guide pin 558 relative to the front upper link 514. Engagement between the guide pins 558 and the walls of the guide slots 560 controls motion of the ladder assembly 500.

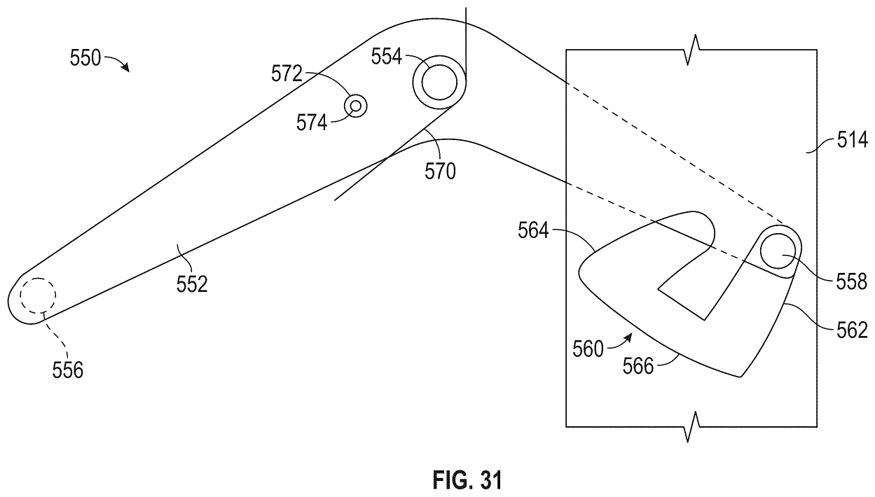

As shown in FIG. 31, each guide slot 560 includes a first portion or inward portion, shown as deployed portion 562. The deployed portion 562 is positioned to receive the guide pin 558 when the ladder assembly 500 is in the fully deployed position. The guide slot 560 includes a second portion or outward portion, shown as storage portion 564. The storage portion 564 is positioned to receive the guide pin 558 when the ladder assembly 500 is in the stored position. The guide slot 560 includes a third portion or connecting portion, shown as free portion 566. The free portion 566 is positioned to receive the guide pin 558 when the ladder assembly 500 is between the stored position and the fully deployed position (e.g., in a partially deployed position). The free portion 566 extends between and connects the deployed portion 562 and the storage portion 564. The deployed portion 562 and the storage portion 564 each extend upward from the free portion 566.

As shown in FIG. 23-27 and 31, the latch assembly 550 further includes a biasing member, shown as torsion spring 570. The torsion spring 570 is coupled to the top step 132A and the arms 552 and extends around the joints 554. The torsion spring 570 applies a biasing force or biasing torque that biases the arms 552 to rotate counter-clockwise as shown in FIG. 31. The biasing torque of the torsion spring 570 biases the guide pin 558 to enter and remain within the deployed portion 562 or the storage portion 564 when aligned with the deployed portion 562 or the storage portion 564. Accordingly, the torsion spring 570 biases the handle 556 to move downward when released by an operator OP.

As shown in FIG. 23-27 and 31, the top step 132A and the arms 552 each define a passage or aperture, shown as locking pin aperture 572, that is sized to receive a locking member or shear member, shown as locking pin 574. When the latch assembly 550 is rotated such that the guide pin 558 is received within the free portion 566 of the guide slot 560, a pin aperture 572 of the top step 132A aligns with a pin aperture 572 of one of the arms 552. Accordingly, a pin 574 may be inserted through the set of pin apertures 572 to limit (e.g., prevent) rotation of the latch assembly 550, holding the guide pin 558 within the free portion 566. The pin 574 may be inserted by an operator OP to prevent the torsion spring 570 from returning the guide pin 558 to engagement with the deployed portion 562 or the storage portion 564.

As shown in FIG. 23-27 and 31, in operation, the latch assembly 550 may selectively lock the ladder assembly 500 in the stored position or the deployed position. Starting with the ladder assembly 500 in the stored position, the guide pin 558 may be received within the storage portion 564 of the guide slot 560 and held in place by the torsion spring 570. The geometry of the guide slot 560 may cause the guide pin 558 to prevent the ladder assembly 500 from extending in this configuration, even when pulled downward by gravity or an operator OP. Accordingly, the guide pin 558 locks the ladder assembly 500 in the stored position. To permit movement of the ladder assembly 500, the operator OP may pull downward on the handle 556, moving the guide pin 558 to the free portion 566 of the guide slot 560. The geometry of the guide slot 560 may permit the guide pin 558 to move freely along the free portion 566 and permit the ladder assembly 500 to extend. When the ladder assembly 500 reaches the fully deployed position, the operator OP may release the handle 556, and the torsion spring 570 may bias the guide pin 558 to enter the deployed portion 562 of the guide slot 560. The geometry of the guide slot 560 may cause the guide pin 558 to prevent the ladder assembly 500 from retracting in this configuration, even when pushed upward by an operator OP. Accordingly, the guide pin 558 locks the ladder assembly 500 in the fully deployed position. A similar process may be followed in reverse when moving from the fully deployed position back to the stored position.

Referring to FIGS. 23, 25, and 32, the platform assembly 54 further includes an actuator assembly 580 that controls the motion of the ladder assembly 500. The actuator assembly 580 includes a linear actuator, shown as actuator 582, that controls motion of the ladder assembly 500. The actuator 582 may extend (e.g., increase in length) to extend the ladder assembly 500 and move the ladder assembly 500 toward the fully deployed position. The actuator 582 may retract (e.g., decrease in length) to retract the ladder assembly 500 and move the ladder assembly 500 toward the stored position. As shown, the actuator 582 is an electric linear actuator (e.g., including an electric motor coupled to a lead screw assembly). In other embodiments, the actuator 582 is a different type of actuator (e.g., a hydraulic cylinder).

As shown in FIGS. 23 and 25, the actuator assembly 580 further includes a first longitudinal support member, actuator cross bar, or mount, shown as frame bar 590. The frame bar 590 is fixedly coupled to the platform frame 100. As shown, the frame bar 590 is coupled to the standoffs 120 and extends longitudinally between the standoffs 120. A first, laterally inward end of the actuator 582 is pivotably coupled to the frame bar 590, such that the actuator 582 is rotatable relative to the frame bar 590 about a longitudinal axis of rotation to facilitate the range of motion of the ladder assembly 500. In some embodiments, the frame bar 590 is removably coupled (e.g., by a series of fasteners) to the platform frame 100 to permit removal of the actuator assembly 580 (e.g., when the ladder assembly 500 is only manually operated).

As shown in FIGS. 23 and 25, the actuator assembly 580 further includes a second longitudinal support member, actuator cross bar, or mount, shown as ladder bar 592. The ladder bar 592 is fixedly coupled to the ladder assembly 500. As shown, the ladder bar 592 extends longitudinally between the rear upper links 512. The ladder bar 592 is coupled to the lower end portions of the rear upper links 512 by a pair of plates or couplers, shown as cheek plates 594. Each cheek plate 594 extends in a vertical and lateral plane and along an inner face of each rear upper link 512. In some embodiments, the cheek plates 594 engage a bottom surface of the top step 132A when the ladder assembly 500 is in the fully deployed position to prevent further extension of the ladder assembly 500. A second, laterally outward end of the actuator 582 is pivotably coupled to the ladder bar 592, such that the actuator 582 is rotatable relative to the ladder bar 592 about a longitudinal axis of rotation to facilitate the range of motion of the ladder assembly 500. In some embodiments, the cheek plates 594 of the ladder bar 592 are removably coupled (e.g., by a series of fasteners) to the rear upper links 512 to permit removal of the actuator assembly 580 (e.g., when the ladder assembly 500 is only manually operated).

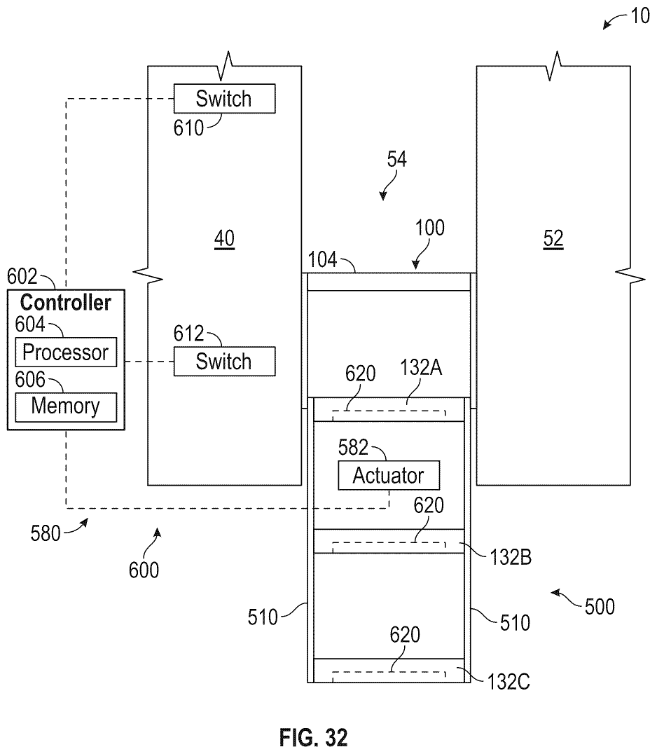

Referring to FIG. 32, the actuator assembly 580 includes a control system 600 for the actuator 582. The control system 600 receives inputs from the operator OP and controls the actuator 582 to extend or retract the ladder assembly 500 accordingly. The control system 600 includes processing circuitry, shown as controller 602. The controller 602 includes a processor 604 and a memory device, shown as memory 606. The memory 606 stores instructions that, when executed by the processor 604, cause the controller 602 to perform the processes described herein. The controller 602 may control operation of the actuator 582. By way of example, the controller 602 may selectively electrically couple the actuator 582 to an electrical energy source (e.g., a battery, a generator, etc.) to control the speed and direction of the actuator 582.

As shown in FIG. 32, the control system 600 includes one or more user interfaces, control interfaces, input devices, or sensors, shown as upper switch 610 and lower switch 612, operatively coupled to the controller 602. The upper switch 610 and the lower switch 612 may each include separate inputs for extending and retracting the ladder assembly 500. By way of example, the upper switch 610 and the lower switch 612 may each include an “up” button and a “down” button. The fire apparatus 10 may further include a second set of the upper switch 610 and the lower switch 612 for independently controlling extension and retraction of a second ladder assembly 500 that is positioned on an opposing side of the fire apparatus 10. The second upper switch 610 and the second lower switch 612 may also be in communication with the controller 602.

As shown in FIG. 32, the upper switch 610 and the lower switch 612 are each coupled to the front cabin 40. In other embodiments, the upper switch 610 and/or the lower switch 612 are otherwise supported (e.g., coupled to the body 52). The upper switch 610 is positioned to facilitate interaction with the operator OP while the operator OP is supported by the operator support surface 104. The lower switch 612 is positioned below the upper switch 610, facilitating interaction with the operator OP while the operator OP is supported by the ground. By way of example, the upper switch 610 and the lower switch 612 may be positioned at or proximate waist height from the operator support surface 104 and the ground, respectively, to facilitate the operator OP pressing the upper switch 610 and the lower switch 612 with their hand.

Referring still to FIG. 32, in operation, the control system 600 utilizes inputs from the upper switch 610 and the lower switch 612 to control operation of the actuator 582. When neither the upper switch 610 nor the lower switch 612 are being interacted with (e.g., pressed), the controller 602 controls the actuator 582 to hold the current position of the ladder assembly 500. Beneficially, the actuator 582 may hold the ladder assembly 500 in any position between the stored position and the fully deployed position. As shown in FIG. 28-30, the steps 132 are all exposed from the outside of the fire apparatus 10 and positioned at regular height intervals throughout the range of motion of the ladder assembly 500. Accordingly, an operator OP may climb or descend the ladder assembly 500 in any position. By using the actuator 582 to hold the ladder assembly 500 in position, the ladder assembly 500 can be used at any level of extension. This may, for example, be advantageous in situations where the fire apparatus 10 is positioned nearby an obstacle that prevents full extension of the ladder assembly 500. In such a situation, the ladder assembly 500 may be partially extended and held in place by the actuator 582, working around the obstacle.

Referring still to FIG. 32, the operator OP may utilize the upper switch 610 and/or the lower switch 612 to extend or retract the ladder assembly 500. By way of example, each of the upper switch 610 and the lower switch 612 may include controls to extend and retract the ladder assembly 500. In response to a command from the operator OP through the upper switch 610 or the lower switch 612 to extend the ladder assembly 500, the controller 602 may control the actuator 582 to extend, moving the ladder assembly 500 toward the fully deployed position. In response to a command from the operator OP through the upper switch 610 or the lower switch 612 to retract the ladder assembly 500, the controller 602 may control the actuator 582 to retract, moving the ladder assembly 500 toward the stored position.

In some embodiments, the control system 600 is configured to limit movement of the ladder assembly 500 beyond the predefined range of motion of the ladder assembly 500. By way of example, the control system 600 may shut off the actuator 582 to prevent extension of the ladder assembly 500 beyond the fully deployed position or retraction of the ladder assembly 500 beyond the stored position. In some embodiments, when the ladder assembly 500 reaches the fully deployed position or the stored position, the ladder assembly 500 experiences a mechanical limit that resists further movement of the ladder assembly 500. By way of example, the stop flange 530 and the cheek plates 594 may resist movement of the ladder assembly 500 beyond the fully deployed position. Once the ladder assembly 500 reaches the fully deployed position, the force on the actuator 582 may increase substantially, causing an increase or spike in the electrical current required to drive the actuator 582. The controller 602 may monitor the current draw of the actuator 582 and shut the actuator 582 off when the current exceeds a predetermined threshold. In this way, the controller 602 prevents the actuator 582 from overdriving the ladder assembly 500. In other embodiments, the control system 600 includes a sensor (e.g., a potentiometer or limit switch) that detects the position of the ladder assembly 500.

Similarly, the controller 602 may limit movement of the ladder assembly 500 when the ladder assembly 500 encounters an obstacle. By way of example, if the ladder assembly 500 encounters an obstacle while extending or retracting, the current draw may exceed the predetermined threshold, and the controller 602 may stop the actuator 582. By way of another example, the control system 600 may include a sensor (e.g., a camera, a switch, etc.) that detects when the ladder assembly 500 contacts or is about to contact an obstacle. The controller 602 may stop the actuator 582 in response to an indication from the sensor that the ladder assembly 500 has contacted or is near an obstacle.

Referring to FIG. 32, in some embodiments, the controller 602 is configured to control the actuators 582 to automatically deploy the ladder assemblies 500 to the fully deployed positions in response to entering a scene mode. The scene mode may represent a configuration of the fire apparatus 10 that is used at the scene of an emergency. The controller 602 may automatically enter the scene mode in response to an indication that the fire apparatus 10 has arrived at the scene. By way of example, the controller 602 may be coupled to or include a global positioning system (GPS) that provides real-time location data indicating a location of the fire apparatus 10. The controller 602 may enter the scene mode in response to the location data indicating that the fire apparatus 10 has entered a geofence surrounding the scene. By way of another example, the controller 602 may enter the scene mode in response to a manual input from a user (e.g., through a user interface, such as a touchscreen or user device).

Referring to FIGS. 23, 25, and 31, the ladder assembly 500 may be manually driven or driven by the actuator 582. In embodiments where the ladder assembly 500 is manually driven, the actuator assembly 580 may be omitted. By way of example, the fasteners attaching the frame bar 590 and the ladder bar 592 may be removed, and the whole of the actuator assembly 580 may be removed. Instead, the operator OP may manually raise and lower the ladder assembly 500. The latch assembly 550 may automatically engage when in the stored position or the fully deployed position to hold the ladder assembly 500 in place. The operator OP may utilize the handle 556 to disengage the latch assembly 550 when moving the ladder assembly 500 out of the stored position or the fully deployed position.

Referring to FIGS. 23, 25, 31, and 32, in embodiments where the ladder assembly 500 is driven by the actuator 582, the latch assembly 550 may be pinned in the disengaged position to prevent the latch assembly 550 from interfering with operation of the actuator 582. By way of example, the pin 574 may be inserted through the pin apertures 572 to hold the latch assembly 550 in the disengaged position. This may permit the actuator 582 to move the ladder assembly 500 freely. In other embodiments, the latch assembly 550 is omitted, and the fire apparatus 10 includes only the actuator assembly 580.

Referring to FIG. 32, the ladder assembly 500 includes light sources or light emitters, shown as lights 620. The lights 620 are each coupled to one of the steps 132 and positioned to emit light downward, toward the ground beneath the ladder assembly 500. When the ladder assembly 500 is extended, the steps 132 are laterally offset from one another, exposing the lights 620 of the top step 132A and the middle step 132B to the ground. The lights 620 may provide lighting to facilitate an operator OP navigating around the fire apparatus 10 in the dark and with climbing the steps 132.

Referring to FIG. 27, the fire apparatus 10 may reconfigurable to vary a width of the platform assembly 54. The fire apparatus 10 may be manufactured in multiple different configurations, depending upon the desired specifications of the end user. To vary the width of the platform assembly 54, the widths of the platform 110, the steps 132, the latch assembly 550, the frame bar 590 and the ladder bar 592 may be varied to provide different vehicle variants. The sizes of the stair linkages 510, the side panels 112, and the actuator 582 may remain consistent between different variants. In one embodiment, the operator support surface 104 is approximately or about 19 inches wide, and the steps 132 are approximately or about 12 inches wide (e.g., measured longitudinally). In another embodiment, the operator support surface 104 is approximately or about 24 inches wide, and the steps 132 are approximately or about 16 inches wide.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire apparatus 10 as shown in the various exemplary embodiments is illustrative only. Additionally, any element disclosed in one embodiment may be incorporated or utilized with any other embodiment disclosed herein.

1. A fire apparatus comprising:
a chassis;
an operator platform coupled to the chassis; and
a pump system including:
a pump configured to provide a flow of a fluid;
an inlet fitting defining an inlet configured to supply the fluid to the pump;
an outlet fitting defining an outlet configured to discharge the fluid from the pump; and
an extension fluidly coupling the inlet fitting and the pump, the extension extending directly beneath the operator platform.

2. The fire apparatus of claim 1, further comprising a step assembly configured to facilitate an operator with accessing the operator platform, wherein the step assembly is positioned between the inlet fitting and the outlet fitting.

3. The fire apparatus of claim 2, wherein the inlet fitting, the outlet fitting, and the step assembly are all positioned on a same side of the fire apparatus.

4. The fire apparatus of claim 2, wherein the step assembly is selectively deployable from a side of the fire apparatus.

5. The fire apparatus of claim 1, wherein the inlet is longitudinally offset from the outlet.

6. The fire apparatus of claim 1, wherein a first one of the inlet fitting or the outlet fitting is positioned rearward of the operator platform, and wherein a second one of the inlet fitting or the outlet fitting is positioned forward of the operator platform.

7. The fire apparatus of claim 6, wherein the inlet fitting is positioned rearward of the operator platform, and wherein the outlet fitting is positioned forward of the operator platform.

8. The fire apparatus of claim 1, wherein the chassis include a pair of frame rails, wherein the pump is positioned between the pair of frame rails, and wherein the inlet fitting and the outlet fitting extend laterally outward and extend downward after extending outside of a respective frame rail of the pair of frame rails.

9. The fire apparatus of claim 1, further comprising:
a water tank positioned rearward of the operator platform;
a junction positioned between the inlet fitting and the extension; and
a conduit extending from the water tank to the junction.

10. The fire apparatus of claim 1, wherein the inlet fitting is a first inlet fitting and the inlet is a first inlet, further comprising:
a second inlet fitting defining a second inlet configured to supply the fluid to the pump; and
a junction positioned between the first inlet fitting, the second inlet fitting, and the extension.

11. The fire apparatus of claim 10, wherein the first inlet is positioned along a first lateral side of the fire apparatus, and wherein the second inlet is positioned along an opposing second lateral side of the fire apparatus.

12. The fire apparatus of claim 1, wherein the outlet fitting is a first outlet fitting and the outlet is a first outlet, further comprising a second outlet fitting defining a second outlet configured to discharge the fluid from the pump.

13. The fire apparatus of claim 12, wherein the first outlet is positioned along a first lateral side of the fire apparatus, and wherein the second outlet is positioned along an opposing second lateral side of the fire apparatus.

14. The fire apparatus of claim 1, further comprising:
a front cabin coupled to the chassis;
a body positioned rearward of the front cabin and the operator platform; and
a control panel coupled to the body and accessible from the operator platform;
wherein the inlet fitting is positioned directly beneath the control panel.

15. A fire apparatus comprising:
a chassis;
a front cabin;
a body;
an operator platform positioned between the front cabin and the body; and
a pump system including:
a pump positioned forward of the operator platform;
an inlet fitting defining an inlet, the inlet positioned rearward of the operator platform;
an extension coupled to the inlet fitting and the pump, the extension extending directly beneath the operator platform; and
an outlet fitting coupled to the pump, the outlet fitting defining an outlet positioned forward of the operator platform.

16. The fire apparatus of claim 15, wherein the inlet fitting is a first inlet fitting and the inlet is a first inlet, further comprising:
a second inlet fitting defining a second inlet, the second inlet positioned rearward of the operator platform; and
a junction positioned between the first inlet fitting, the second inlet fitting, and the extension.

17. The fire apparatus of claim 16, wherein the first inlet is positioned along a first lateral side of the fire apparatus, and wherein the second inlet is positioned along an opposing second lateral side of the fire apparatus.

18. The fire apparatus of claim 15, wherein the outlet fitting is a first outlet fitting and the outlet is a first outlet, further comprising a second outlet fitting coupled to the pump, wherein the second outlet fitting defines a second outlet positioned forward of the operator platform, wherein the first outlet is positioned along a first lateral side of the fire apparatus, and wherein the second outlet is positioned along an opposing second lateral side of the fire apparatus.

19. A fire apparatus comprising:
a chassis;
a front cabin;
a body;
a water tank disposed within the body;
an operator platform positioned between the front cabin and the body;
an operator interface coupled to the body and accessible from the operator platform; and
a pump system including:
a pump positioned forward of the operator platform;
an inlet fitting defining an inlet, the inlet positioned rearward of the operator platform;
a conduit coupled to the water tank;
a junction coupled to the inlet fitting and the conduit, the junction positioned rearward of the operator platform;
an extension coupled to the junction and the pump, the extension extending directly beneath the operator platform; and
an outlet fitting coupled to the pump, the outlet fitting defining an outlet positioned forward of the operator platform.

20. The fire apparatus of claim 19, further comprising a step assembly configured to facilitate an operator with accessing the operator platform, wherein the step assembly is positioned between the inlet fitting and the outlet fitting, and wherein the step assembly is selectively deployable from a side of the fire apparatus.
